(19) United States
(12) Patent Application Publication
(10) Pub. No.: US 2003/0023516 A1
(43) Pub. Date: Jan. 30, 2003

(54) Inventory management database

(76) Inventors: Sherry L. Sharrow, Fredericksburg, VA (US); William J. Krainski, Locust Grove, VA (US)

Correspondence Address: James B. Bechtel, Esq., NSWCDD (CD222), Dahlgren, VA, 22448-5100, US

(21) Appl. No.: 09/860,115

(22) Filed: May 17, 2001

(51) Int. Cl. G06F 17/60

(52) U.S. Cl. 705/28

(57) ABSTRACT

An inventory management database is disclosed. The database can include container objects, hardware component objects, and software component objects. Container objects correspond to equipment on which other equipment can be installed. Hardware component objects correspond to hardware components that are installable on the equipment to which the container objects correspond. When a hardware component is installed on the equipment to which a container object corresponds, the corresponding hardware component object is assigned to this container object. Software component objects correspond to software components that are also installable on the equipment to which the container objects correspond. When a software component is installed on the equipment to which a container object corresponds, the corresponding software component object is assigned to this container object.

### STATEMENT REGARDING THE PATENT

The invention described herein may be manufactured and used by or for the Government of the United States of America for governmental purposes without the payment of any royalties thereon or therefor.

### FIELD OF THE INVENTION

This invention relates generally to databases, and more particularly to inventory management databases.

### BACKGROUND OF THE INVENTION

Most large organizations have an increasing amount of electronic equipment, such as computer equipment. Most employees, for instance, are equipped with a phone and a computer system. The computer system may include the computer itself, a monitor, and optionally a printer and other peripherals. The computer itself typically includes a hard disk drive or other mass storage device, a network adapter card, and other equipment, as well as software installed on the computer and which resides on the hard disk drive. Shared equipment may include network printers, network hubs, fax machines, and so on.

For inventory and other purposes, organizations have found a need to manage this equipment. Equipment that is purchased is considered an investment on the part of an organization, and should be tracked for at least this reason, whereas equipment that is leased should be tracked to know when the equipment is due to be returned. In the case of software, organizations must track the number of licensed users they have for a given piece of software, so that they do not run afoul of any licensing agreements.

Current inventory management systems are less than optimal, however. They are typically based on flat-file databases, which limits their flexibility and extendibility. The systems may not have the ability to enter in the wide variety of different hardware found in the typical large organization. Furthermore, whereas they may be able to track equipment that has been installed, they usually cannot track equipment that has yet to be installed, or cannot accommodate equipment moving from one user or location to another. For these and other reasons, therefore, there is a need for the present invention.

### SUMMARY OF THE INVENTION

The invention relates to an inventory management database. The database can include container objects, hardware component objects, and software component objects. Container objects correspond to equipment on which other equipment can be installed. Hardware component objects correspond to hardware components that are installable on the equipment to which the container objects correspond. When a hardware component is installed on the equipment to which a container object corresponds, the corresponding hardware component object is assigned to this container object. Software component objects correspond to software components that are also installable on the equipment to which the container objects correspond. When a software component is installed on the equipment to which a container object corresponds, the corresponding software component object is assigned to this container object.

The invention provides for advantages not found within the prior art. The nature of the objects being container, hardware component, or software component objects means that the installation relationship among equipment is reflected within the database. For instance, when hardware is removed from a system and placed in storage, a corresponding hardware component object is unassigned from a corresponding container object, and subsequently becomes available for assignment to other container objects. Furthermore, because different types of objects can be created, the database allows for the management of a wide variety of different inventory. Other aspects, embodiments, and advantages of the invention will become apparent by studying the detailed description that follows and by referencing the accompanying drawings.

### BRIEF DESCRIPTION OF THE DRAWINGS

FIG. 1 is a diagram showing the types of objects that can populate a database according to the invention.

FIG. 2 is a diagram showing the object types are selected to populate a database according to the invention.

FIG. 3 is a diagram of a screen shot of the main menu of an exemplary embodiment of the invention.

FIGS. 4-11 are diagrams of screen shots shown when the system information option of FIG. 3 is selected.

FIG. 12 is a diagram of a screen shot of the enter components menu when the enter components option of FIG. 3 is selected.

FIGS. 13-14 are diagrams of screen shots shown when the hardware components option of FIG. 12 is selected.

FIG. 15 is a diagram of a screen shot of the network components menu shown when the network components option of FIG. 12 is selected.

FIGS. 16-17 are diagrams of screen shots shown when the network cards option of FIG. 15 is selected.

FIGS. 18-20 are diagrams of screen shots shown when the network hubs option of FIG. 15 is selected.

FIGS. 21-22 are diagrams of screen shots shown when the network modules option of FIG. 15 is selected.

FIGS. 23-24 are diagrams of screen shots shown when the network sub-modules option of FIG. 15 is selected.

FIGS. 25-28 are diagrams of screen shots shown when the network print servers option of FIG. 15 is selected.

FIGS. 29-30 are diagrams of screen shots shown when the mass storage components option of FIG. 12 is selected.

FIGS. 31-33 are diagrams of screen shots shown when the printer components option of FIG. 12 is selected.

FIG. 34 is a diagram of a screen shot of the software components menu shown when the software components option of FIG. 12 is selected.

FIGS. 35-36 are diagrams of screen shots shown when the software components option of FIG. 34 is selected.

FIG. 37 is a diagram of a screen shot shown when the hot fixes option of FIG. 34 is selected.

FIG. 38 is a diagram of a screen shot shown when the service packs option of FIG. 34 is selected.

FIG. 39 is a diagram of a screen shot of the STU phone components menu shown when then the STU phone components option of FIG. 12 is selected.

FIG. 40 is a diagram of a screen shot shown when the STU phone information option of FIG. 39 is selected.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, electrical, and other changes may be made without departing from the spirit or scope of the present invention. The following detailed description is, therefore, not to be taken in a limiting sense, and the scope of the present invention is defined only by the appended claims.

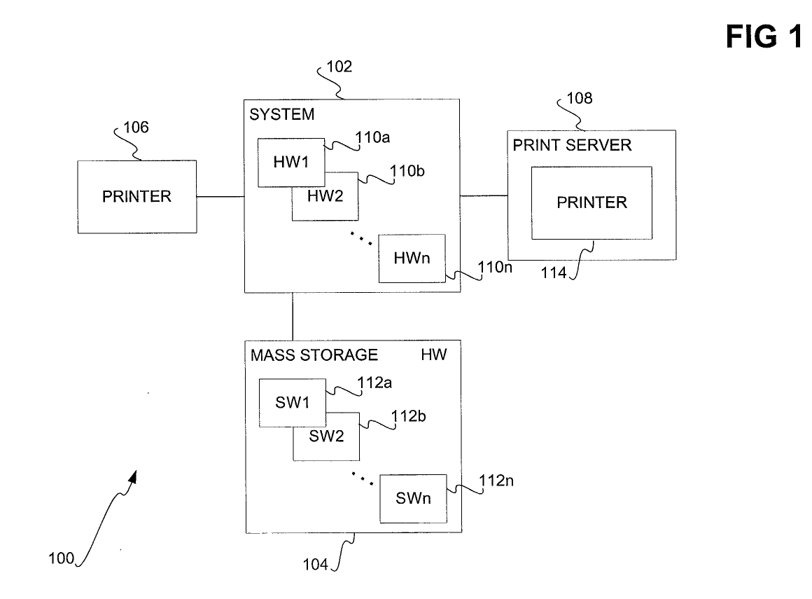

FIG. 1 is a diagram showing an overview of a database 100 according to the invention. The database 100 is preferably a relational database. The database 100 contains different types of virtual container objects. For purposes of clarity only, one of each different type is shown in FIG. 1: a system container object 102, a mass storage container object 104, a printer container object 106, and a print server container object 108. There can be more or less of each type of container object than that shown in FIG. 1. An object can be defined generally and non-restrictively as a self-contained module of data.

Each container object is used for the assignment or installation of other types of component objects. For instance, the system container object 102 has assigned thereto hardware component objects 110a, 110b, . . . , 100n. Each of these objects may correspond to a different type of hardware installed on the system to which the object 102 corresponds. Such hardware may be network adapters, graphics cards, monitors, keyboards, and so on. When the system container object 102 has a hardware component object assigned to it, this means that the hardware component represented by the object has been installed on the system represented by the object 102.

The mass storage container object 104 is both a type of hardware component object that can be assigned to a particular system object, in this case the system container object 102, and that can also have software component objects assigned to it. More accurately, the mass storage container object 104 should be shown in FIG. 1 as inside the system container object 102, but for sake of illustrative clarity it is shown as outside the object 102. The mass storage container object 104 has assigned thereto software component objects 112a, 112b, . . . , 112n. Each of these objects may correspond to a different type of software installed on the system represented by the container object 102 to which the mass storage container object 104 has been assigned. Such software may include word processing programs, email programs, operating systems, other software programs, update programs, and so on. When the mass storage container object 104 has a software object assigned to it, this means that the software component represented by the object has been installed on the system represented by the object 102.

The printer container object 104 is also both a type of hardware component object that can be assigned to a particular system object, and a container object that can have other hardware component objects assigned to it. However, as shown in FIG. 1, the printer container object 104 is only the former, having been assigned to the system 102 to indicate that the printer represented by the object 104 has been installed on the system 102. Conversely, the print server object 104 is a container object that can have hardware component objects representing printers assigned to it. For instance, the print server object 104 has the printer component object 114 assigned thereto, meaning that the printer represented by the object 114 has been assigned to the print server represented by the object 104.

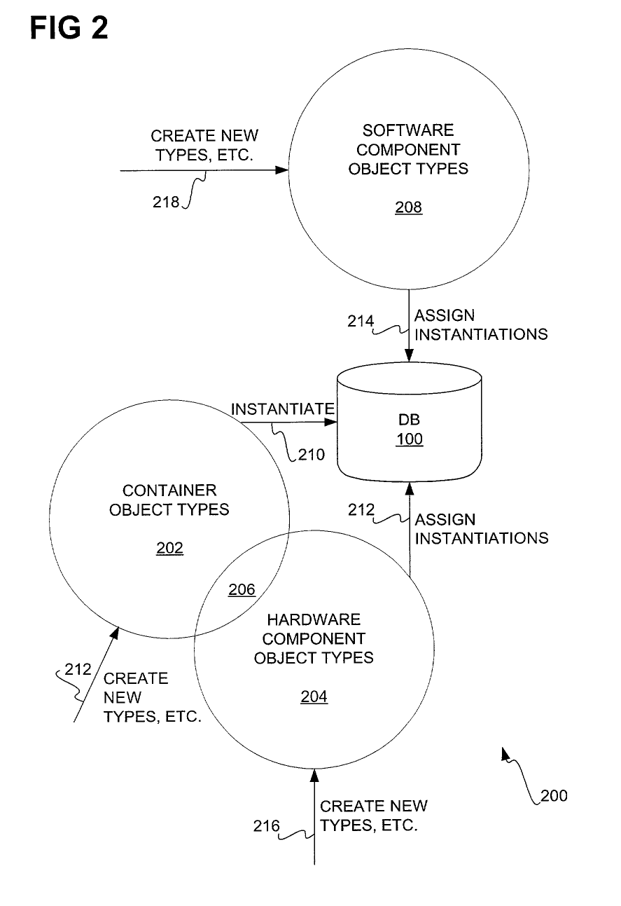

FIG. 2 is a diagram showing the overall process 200 as to how the database 100 is populated. There is a container object types pool 202 that includes all the different types of container objects that can be instantiated to populate the database 100. There also is a hardware component object types pool 204 that includes all the different types of hardware component objects that can be instantiated and assigned to particular container objects in the database 100. (More accurately, objects in the database 100 should be referred to as instances of objects, but for sake of brevity, are just referred to as objects herein.) Because some hardware component object types are also container object types, there is an area of overlap 206 between the pools 202 and 204. Furthermore, there is a software component object types pool 208 that includes all the different types of software component objects that can be instantiated and assigned to particular container objects in the database 100.

Therefore, the process 200 of using the database 100 includes selecting from the container object types pool 202 to determine which of container object types to instantiate into the database 100, as represented by the arrow 210. An administrator may also create, modify, and delete container object types within the pool 202, as indicated by the arrow 212. Once one or more container object types from the pool 202 have been instantiated into the database 200, hardware component objects from the hardware component object types pool 204 may be instantiated into the database 100, and assigned to particular container objects that already exist in the database 100. This is represented by the arrow 212. Similarly, software component objects from the software component object types pool 208 may be instantiated into the database 100, and assigned to particular container objects that exist in the database 100, as represented by the arrow 214. The administrator may also create, modify, and deleted hardware and software component object types from the pools 204 and 208, as indicated by the arrows 216 and 218, respectively.

In summary, a user wishing to use the database 100 first creates container objects in the database 100, of the types represented in the pool 202. Such container objects may include system objects, mass storage objects, and so on. The user then creates hardware component objects in the database 100, of the types represented in the pool 204, and assigns them to particular container objects that already exist in the database 100. For example, the user may create a network adapter card object, and assign it to a system object that has already been created in the database 100. The user also creates software component objects in the database 100, of the types represented in the pool 208, and assigns them to particular container objects that already exist in the database 100. For example, the user may create an office suite software object, and assign it to a mass storage object that has already been created in the database 100.

An exemplary embodiment of the invention is implemented in conjunction with the MICROSOFT ACCESS database program, available from Microsoft Corporation of Redmond, Wash. The VISUAL BASIC for APPLICATIONS (VBA) programming language, which is a part of this database program, is also used for implementation of the exemplary embodiment. However, other database programs and programming languages are also amenable for implementation of the invention.

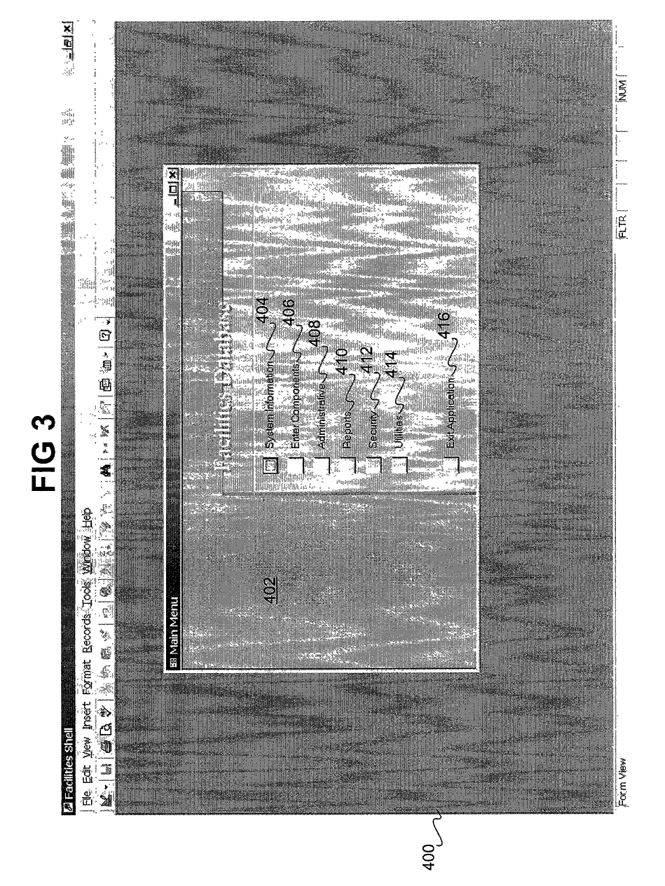

The exemplary embodiment is described by reference to a series of screen shots of FIGS. 3-40. These screen shots show example screens that can be displayed for the user to enter, modify, and delete information for hardware and software component objects, as well as for container objects. The information shown on these screen shots is stored within the objects in the database to which the screen shots correspond. For example, information shown on a screen shot for a software component is stored in a software component object corresponding to and representing the software component.

The series of screen shots of FIGS. 3-40 also implicitly show the flow of information entry and display within the exemplary embodiment. That is, a screen shot may be described as being displayed when an option on another screen shot is selected, and so on. This description implies that the flow of the database is such that the former screen shot is displayed when the option on the latter screen shot is selected. From the description of the series of screen shots of FIGS. 3-40, in conjunction with the description of FIGS. 1-2 already provided, those of ordinary skill within the art are able to make and use embodiments of the invention, specifically the exemplary embodiment.

FIG. 3 shows a diagram of a screen 400 in which there is the main database window 402. Options 404, 406, 408, 410, 412, 414, and 416 are selectable by the user. These options correspond to the system information, enter components, administrative, reports, security, utilities, and exit application options, respectively. The system information option 404 allows the user to enter in new systems, such that new system container objects are instantiated. The user may edit and remove systems as well. This option also allows the user to install software and hardware in these systems, such that new component objects are instantiated and assigned to the system and other container objects. The enter components option 406 allows the user to enter in new hardware and software objects, such that new component objects are created for subsequent assignment.

The system information option 404 and the enter component option 406 are the primary options of the inventive inventory management database, and are described in depth in this application. The other options 408, 410, 412, 414, and 416 are options typically found in database programs, and therefore are described in a more limited manner. Selecting the option 408, for instance, allows the user to perform various administrative tasks for the database, whereas selecting the option 410 allows the user to print various reports regarding the data stored in the database. Selecting the option 412 allows the user to specify access security for the database, and selecting the option 414 allows the user to perform various utility functions within the database, such as maintaining user names, and so on. Finally, selecting the option 416 causes the database program to end.

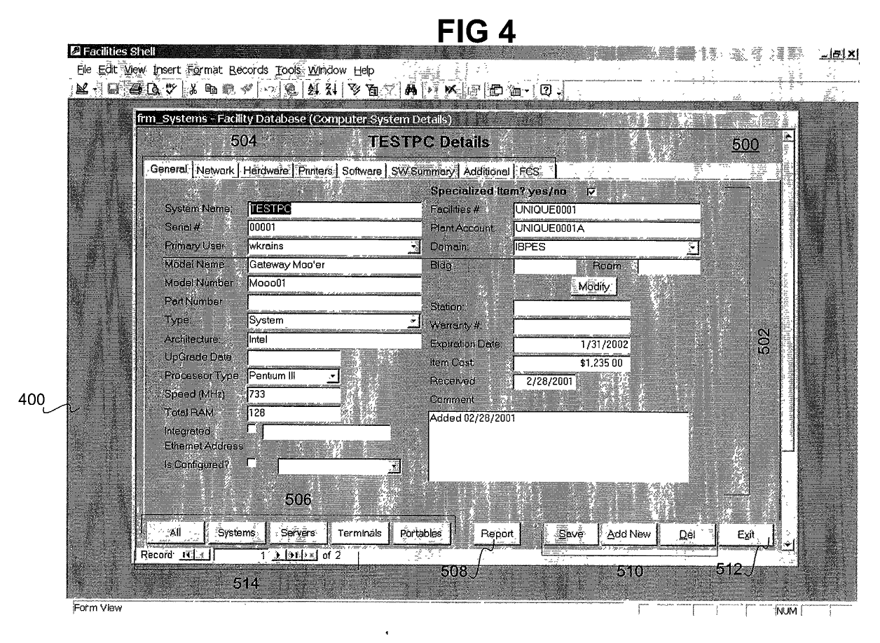

Selecting the system information option 404 brings up the window 500 of FIG. 4. The window 500 includes a number of different parts. The main area 502 shows information regarding a specific system, represented by a system container object within the database. As shown in FIG. 4, this information can include the following information: system name, serial number, primary user, model name, model number, part number, type, architecture, upgrade date, processor type, speed, total random access memory (RAM), whether it is integrated, Ethernet address, and whether it is configured. Furthermore, the information may also include whether the system is specialized, the facilities number, plant account, domain, building, room, station, warranty number, expiration date, cost, when received, and additional comments.

The window 500 includes a number of different tabs 504, such that the main area 502 corresponds to the general tab. Other tabs include the network, hardware, printers, software, software summary, additional, and fire control system (FCS, which is a special type of equipment) tabs, which are explained in more detail later in the application. The window 500 further includes buttons 506,508,510, and 512. The buttons 506 indicate the different types of systems, including all systems, (desktop) systems only, servers only, terminals only, and portables only. The report button 508 allows the user to print a report. The buttons 510 allow the user to save changes made within the window 500, add a new system container object, and delete the current system object. The exit button 512 allows the user to close the window 500 go back to the window 402 of FIG. 3.

The records area 514 allows the user to navigate among the different records, or system container objects. The different records that the user can navigate among are specified by the buttons 506. For example, pressing the all system button allows the user to navigate among all the system container objects, whereas pressing the servers only button allows the user to navigate only among the system container objects representing servers.

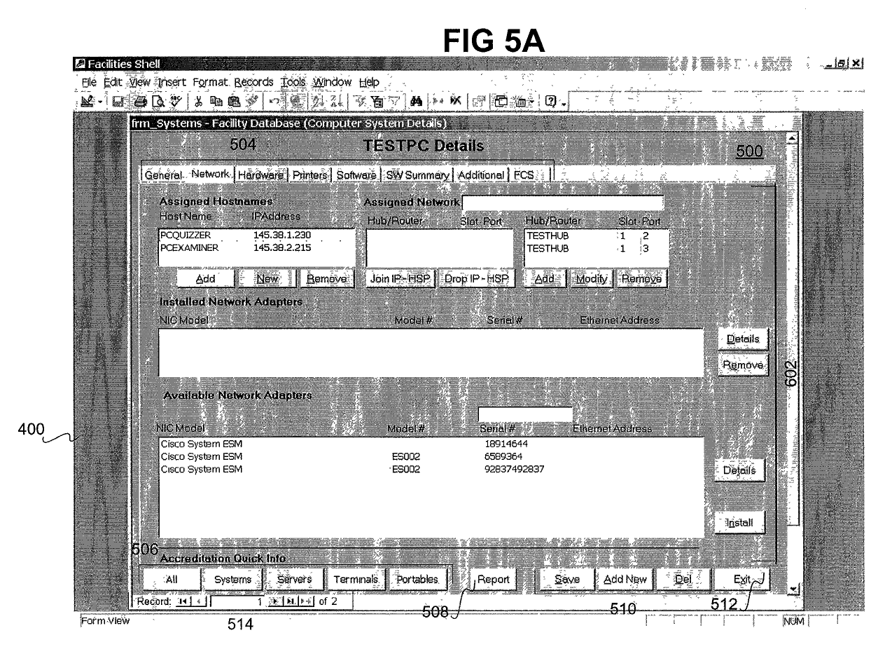

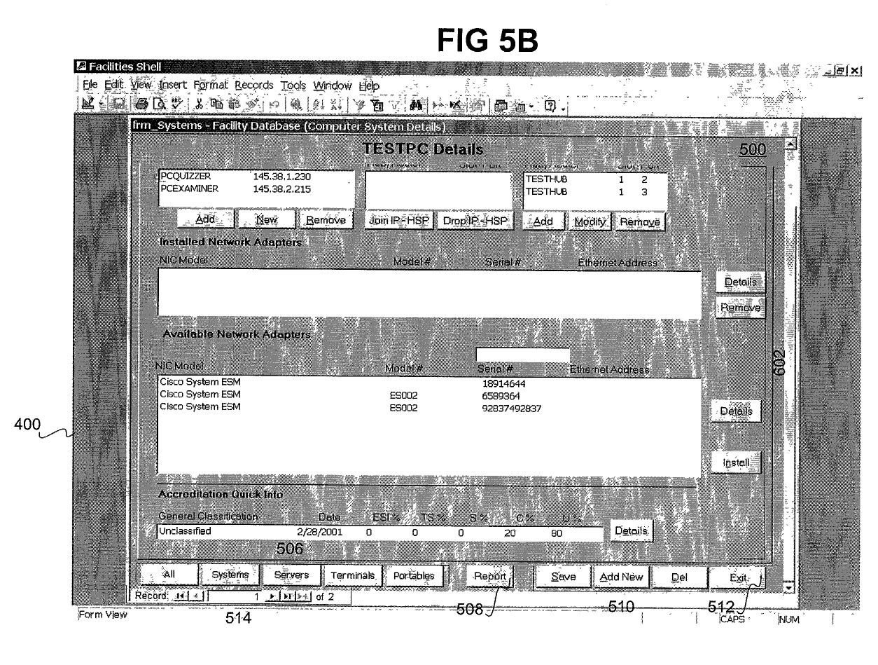

Clicking on the network tab of the tabs 504 causes the network information area 602 of FIG. 5 to be displayed within the window 500. The network information area 602 includes a number of different types of information. First, the information includes the assigned hostnames, assign network, and various hubs and routers regarding the current system. These may be added, removed, modified, joined, dropped, and so on, as indicated in FIG. 5. Second, the network information includes the installed network adapters. The installed network adapters are component objects that have been instantiated and assigned to the current system container object. Third, the network information includes available network adapters that can be installed to the current system. The available network adapters are component objects that can be assigned to the current system container object. Finally, the network information includes accreditation information.

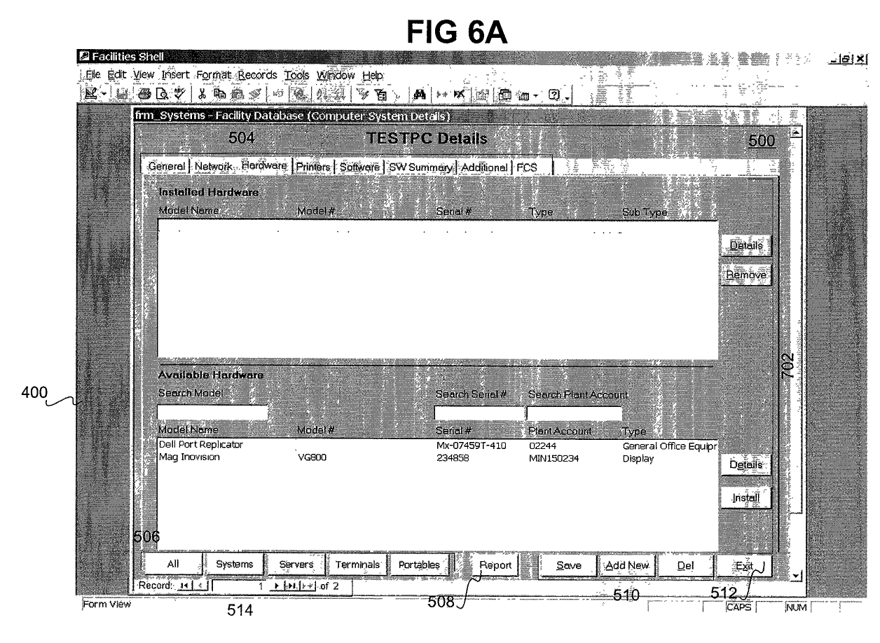

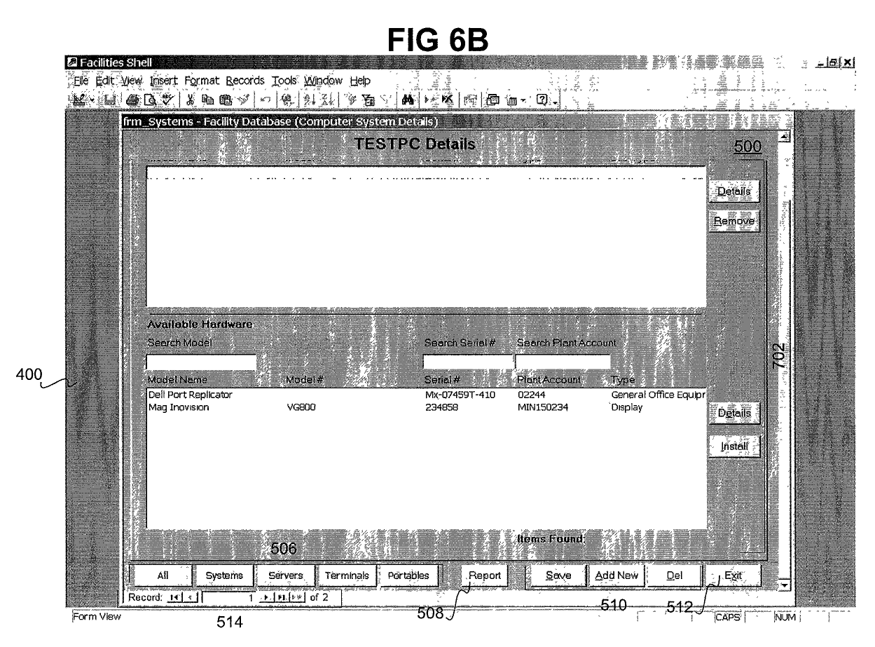

Clicking on the hardware tab of the tabs 504 causes the hardware information area 702 of FIG. 6 to be displayed within the window 500. The hardware information area 702 includes two different types of information. First, the information includes the installed hardware on the current system. The installed hardware is a list of the hardware component objects that have been instantiated and assigned to the current system container object. The information for each piece of hardware can include the model name, model number, serial number, type, and sub-type of the hardware. Second, the hardware information includes the hardware that is available to be installed. This is a list of the hardware component objects that can be assigned to the current system container object. If the list of available hardware is too great for manual scrolling, a specific type of hardware can be searched for by model, serial number, or plant account.

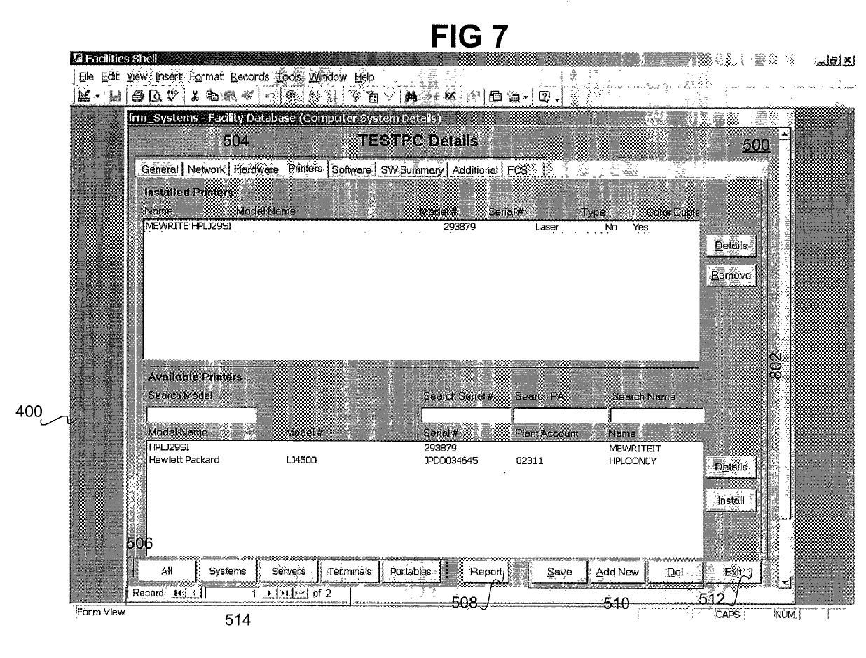

Clicking on the printers tab of the tabs 504 causes the printer information area 802 of FIG. 7 to be displayed within the window 500. The printer information area 802 includes two different types of information. First, the information includes the installed printers on the current system. The installed printers are the printer component objects that have been instantiated and assigned to the current system container object. The information for each printer can include the printer name, model name, model number, serial number, type, and feature specifications, such as color, duplex, and so on. Second, the printer information includes the printers that are available to be installed. These printer component objects can be assigned to the current system container object. If the list of available printers is too great for manual scrolling, a specific printer can be searched for by printer name, model name, serial number, or plant account.

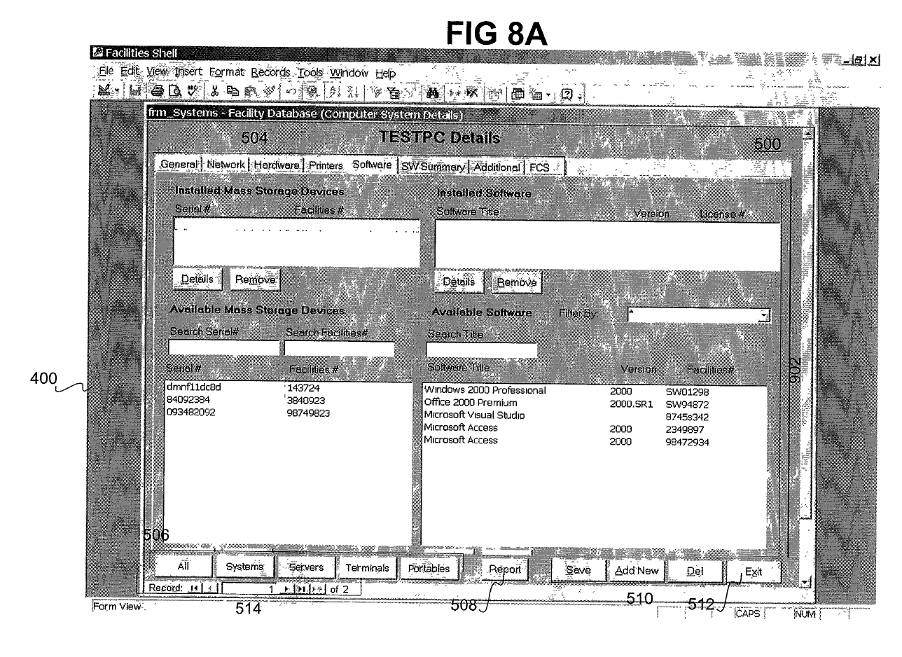

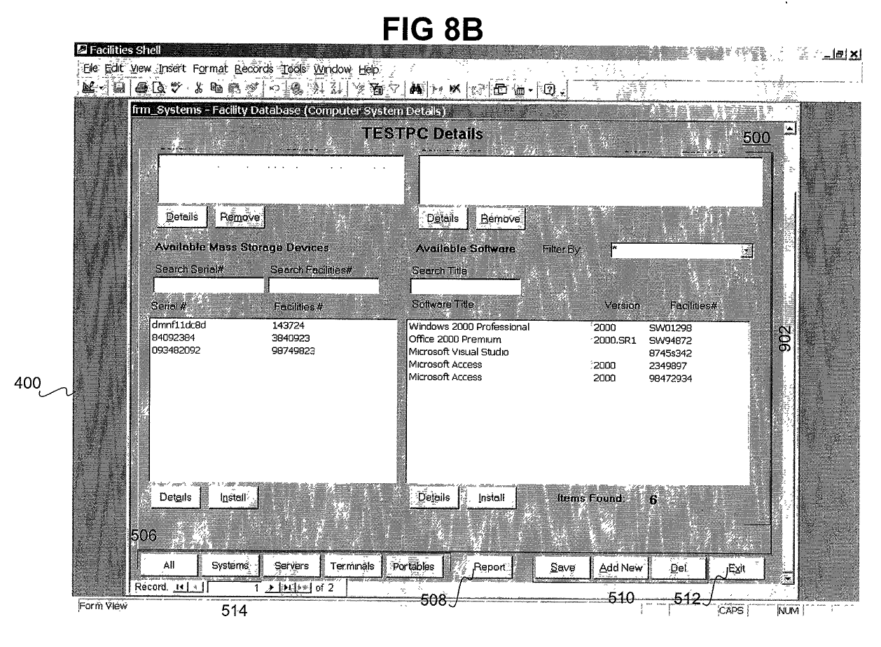

Clicking on the software tab of the tabs 504 causes the software information area 902 of FIG. 8 to be displayed within the window 500. The software information area 902 includes different types of information. First, installed and available mass storage devices are shown. The installed mass storage devices are the mass storage hardware component objects that have been instantiated and assigned to the current system container object, whereas the available mass storage devices are the mass storage hardware component objects that can be assigned to the current system container object. For both the installed and available mass storage devices, their serial and facility numbers are shown. The available mass storage devices may further be searched for by serial or facility number. Details regarding an installed mass storage device can be viewed, and an installed mass storage device can be removed. Similarly, details regarding an available mass storage device can be viewed, and an available mass storage device can be installed, such that it is added to the list of installed mass storage devices.

Second, installed and available software is shown. The installed software is the list of software component objects that have been instantiated and assigned to one of the mass storage device objects assigned to the current system container object. The available software is the list of software component objects that can be assigned to one of the mass storage device objects assigned to the current system container object. For both the installed and available software, their software title, version, and other information are shown. The available software can be searched for by title. Details regarding installed software can be viewed, and installed software can be removed. Similarly, details regarding available software can be viewed, and available software can be installed, such that it is added to the list of installed software.

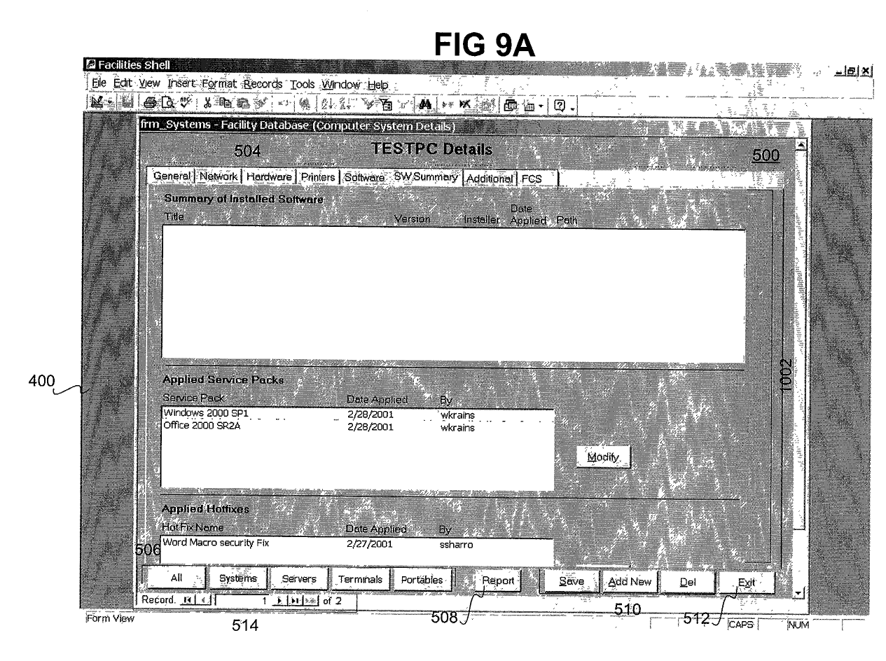

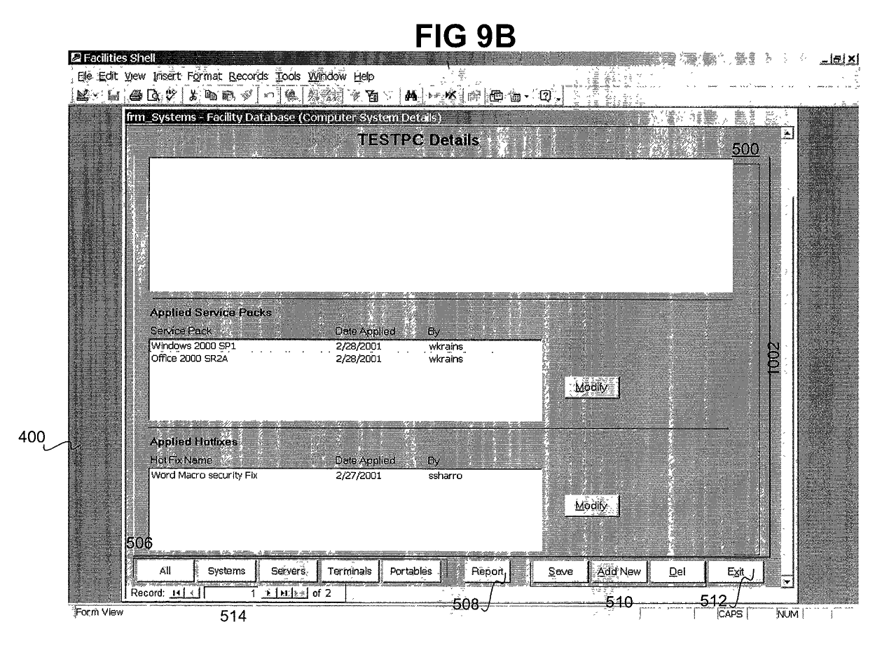

Clicking on the software summary tab of the tabs 504 causes the software summary information area 1002 of FIG. 9 to be displayed within the window 500. The software information area 1002 includes a summary of the software that has been installed on the current system, as well as service packs and hot fixes that have been applied to the current system. Service packs are update programs provided by vendors to update their software between major versions. Hot fixes are also update programs provided by vendors, but are generally narrower in scope than service packs. Both the service packs and the hot fixes applied to the current system can be modified.

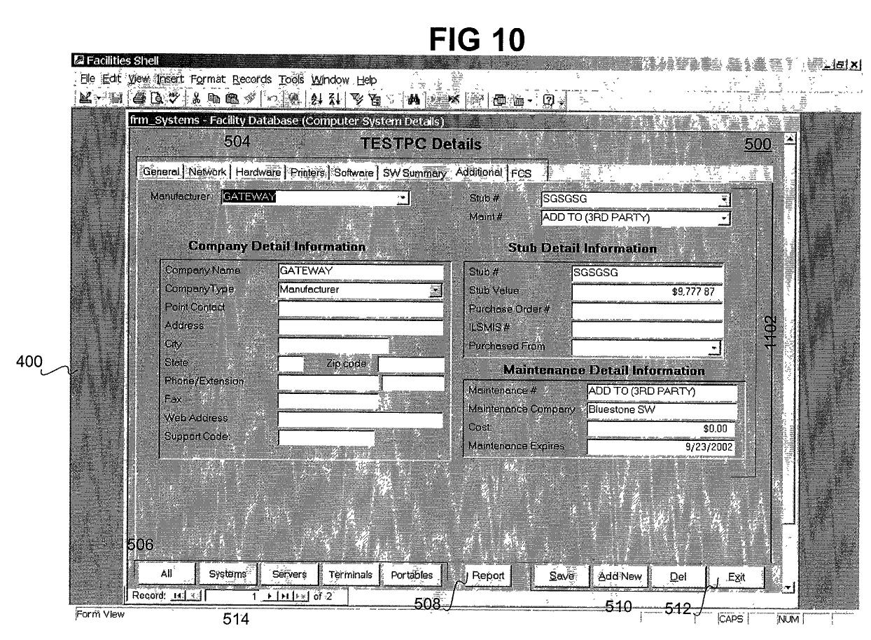

Clicking on the additional tab of the tabs 504 causes the additional information area 1102 of FIG. 10 to be displayed within the window 500. The additional information area 1102 provides further information regarding the current system, such as the manufacturer of the system, company information, stub (or, invoice) information, and maintenance information. Similarly, clicking on the FCS tab of the tabs 504 causes the FCS information area 1202 of FIG. 11 to be displayed within the window 500, which provides other information regarding the current system. This information can include the owner, system location, operating system, and so on, as shown in FIG. 11.

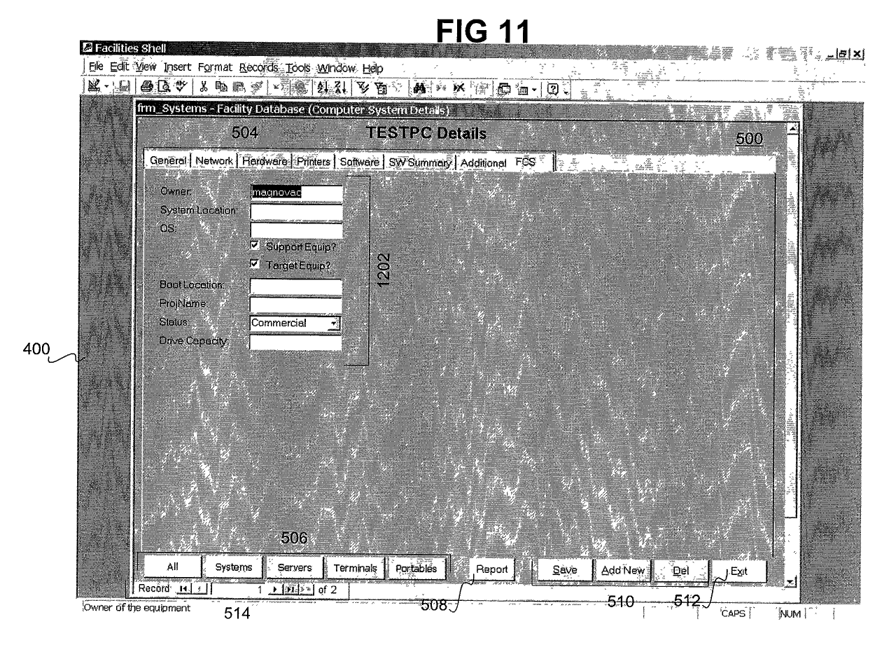

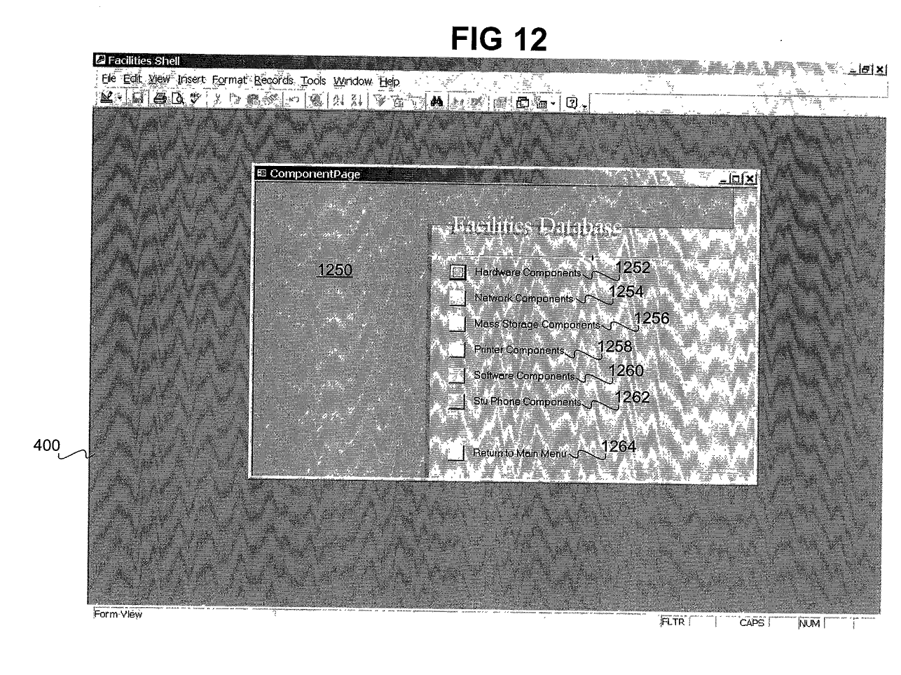

Referring back to FIG. 3, selecting the enter components option 406 brings up the window 1250 of FIG. 12. Seven different options are selectable in the window 1250. The user may specify hardware components 1252, network components 1254, mass storage components 1256, printer components 1258, software components 1260, and STU (secure telephone unit, a special type of telephony equipment) phone components 1262. The user may also return to the window 402 of FIG. 3 by selecting the return to previous menu option 1264.

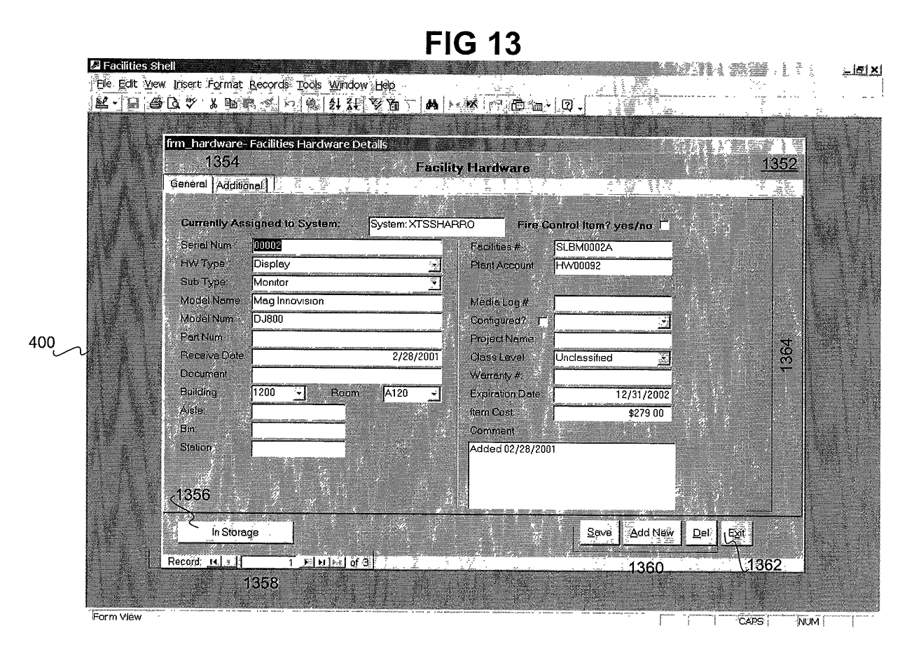

Selecting the option for the hardware components 1252 brings up the window 1352 of FIG. 13. The window 1352 includes a number of different parts. The main area 1364 shows general information regarding a current hardware component that can be or is installed on a system, where the hardware component is represented by a hardware component object within the database. As shown in FIG. 13, the general information can include where the hardware is currently installed, serial number, hardware type, hardware sub-type, model name, model number, part number, receive date, document, building, room, aisle, bin and station. The type of hardware may include displays, docking stations, general office equipment, imaging equipment, input devices, interface drives, logic analyzers, memory, modems, network devices, removable hard drive cases, scanners, storage devices, terminals, test tools, uninterruptible power supplies, workstations, and zip drives. The general information can also include whether it is a fire control item, facilities number, plant account, media log number, project name, class level, warranty number, expiration date, item cost, and comments.

The button 1356 is used to indicate that the current hardware component is in storage. The buttons 1360 allow the user to save changes made within the window 1352, add a new hardware component object, and delete the current object. The exit button 1362 allows the user to close the window 1352 and go back to the window 1250 of FIG. 12. The window 1352 includes two tabs 1354, where the main area 1364 corresponds to the general tab, and there also is an additional information tab. The records area 1358 allows the user to navigate among the different records, or hardware component objects.

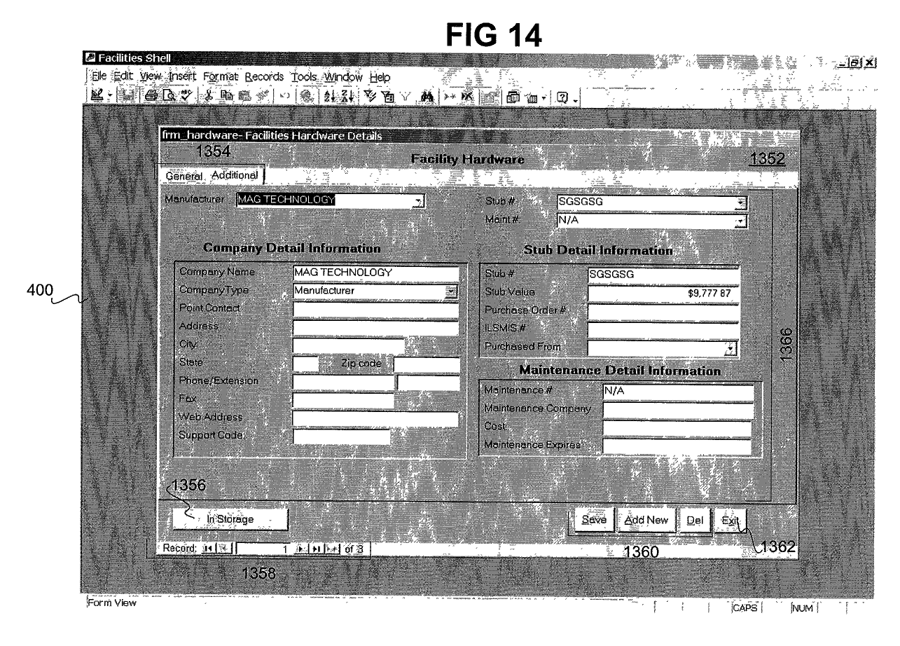

Clicking on the additional tab of the tabs 1354 causes the additional information area 1366 of FIG. 14 to be displayed within the window 1352. The additional information area 1366 includes additional information regarding the current hardware component. This additional information can include manufacturer (company) information, stub information, and maintenance information.

Referring back to FIG. 12, selecting the option for the network components 1254 brings up the window 1300 of FIG. 15. Six different options are selectable in the window 1300. The user may specify network cards 1302, network hubs 1304, network modules 1306, network sub-modules 1308, or network print servers 1310. The user may also return to the window 1250 of FIG. 12 by selecting the return to previous menu option 1312.

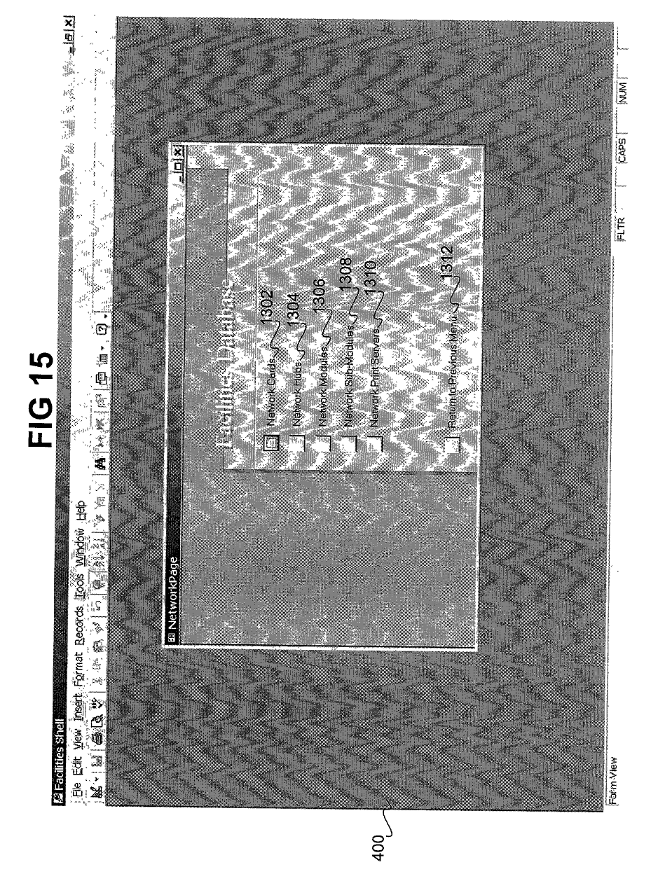

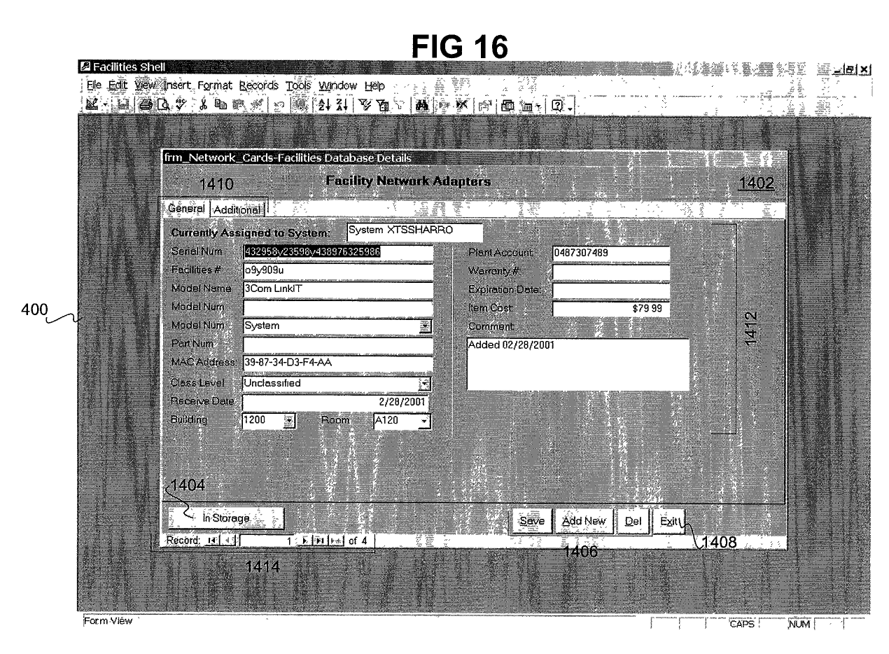

Selecting the option for the network cards 1302 brings up the window 1402 of FIG. 16. The window 1402 includes a number of different parts. The main area 1412 shows general information regarding a current network card that can be installed on a system, where the network card is represented by a component object within the database. As shown in FIG. 16, the general information can include the following: the system the card is assigned to (if any), serial number, facilities number, model name, model number, part number, MAC address, class level, receive date, building and room. The general information can also include plant account number, warranty number, expiration date, item cost, and comments.

The button 1404 is used to indicate that the current network card is in storage. The buttons 1406 allow the user to save changes made within the window 1402, add a new network card component object, and delete the current network card component object. The exit button 1408 allows the user to close the window 1402 and go back to the window 1300 of FIG. 15. The window 1402 also includes two tabs 1410, such that the main area 1412 corresponds to the general tab. The other tab is the additional information tab. The records area 1414 allows the user to navigate among the different records, or network card component objects.

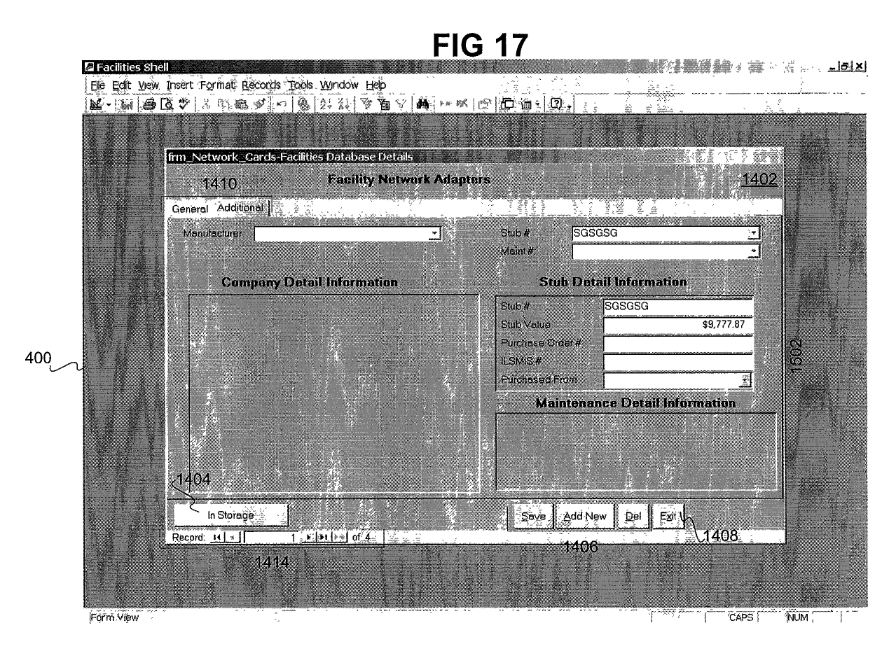

Clicking on the additional tab of the tabs 1410 causes the additional information area 1502 of FIG. 17 to be displayed within the window 1402. The additional information area 1502 shows and allows entry of additional information regarding the current network card. This information includes manufacturer, stub information, and maintenance information.

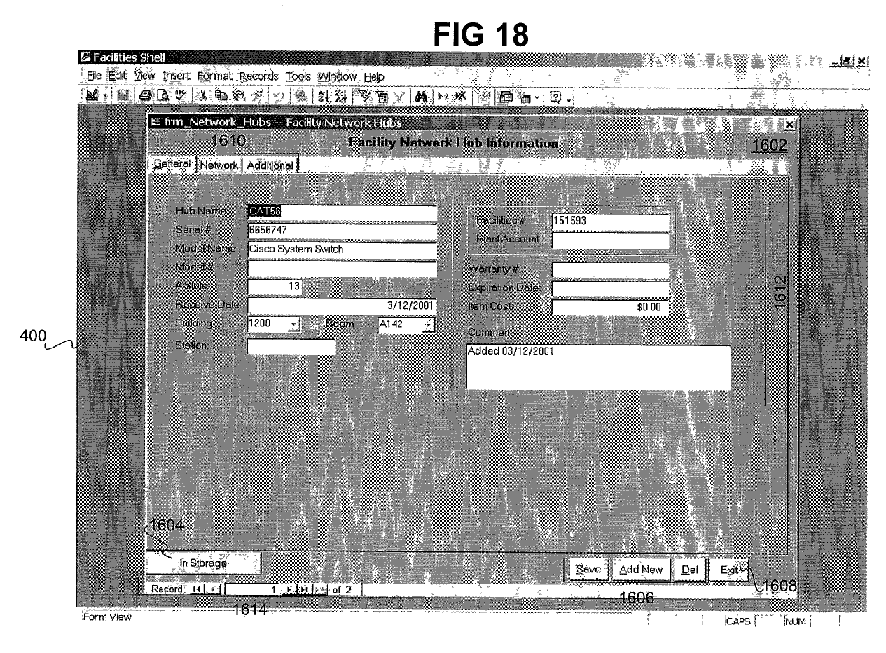

Referring back to FIG. 15, selecting the option for the network hubs 1304 brings up the window 1602 of FIG. 18. The window 1602 includes a number of different parts. The main area 1612 shows general information regarding a current network hub that can be installed on a system, where the network hub is represented by a hardware component object within the database. As shown in FIG. 18, the general information can include hub name, serial number, model name, model number, number of slots, receive date, building, room, and station. The general information can also include facilities number, plant account, warranty number, expiration date, item cost, and comments.

The button 1604 is used to indicate that the current network hub is in storage. The buttons 1606 allows the user to save changes made within the window 1602, add a new network hub component object, and delete the current network hub component object. The exit button 1608 allows the user to close the window 1602 and go back to the window 1300 of FIG. 15. The window 1602 includes three tabs 1610, where the main area 1612 corresponds to the general tab, and there are network and additional information tabs, too. The records area 1614 allows the user to navigate among the different records, or network hub component objects.

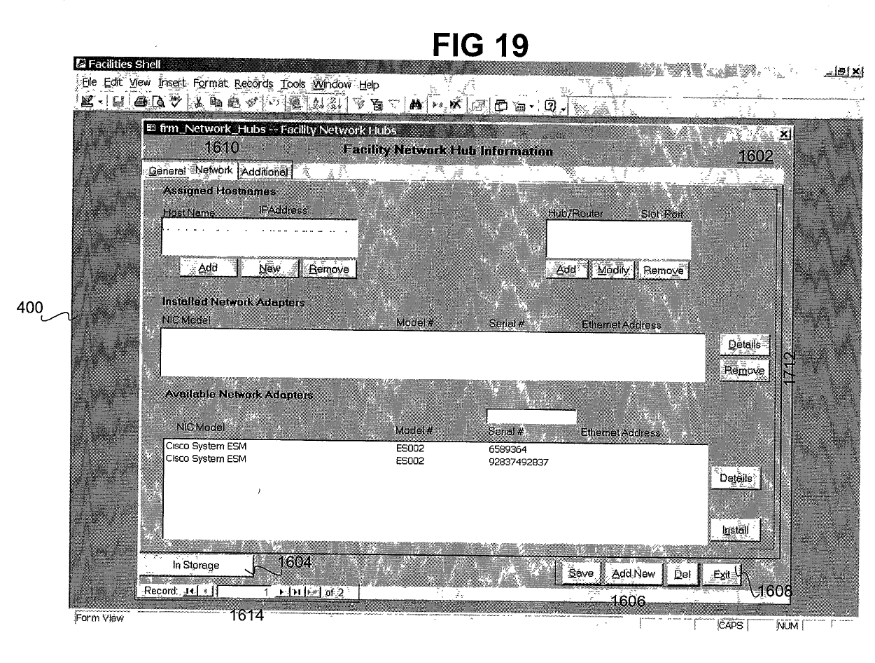

Clicking on the network tab of the tabs 1610 causes the network information area 1712 of FIG. 19 to be displayed within the window 1602. The network information area 1712 includes information regarding the current network hub. This information includes assigned hostnames, installed network adapters, and available network adapters. Assigned hostnames may be added and removed. Similarly, network adapters may be added or removed, and correspond to network adapter component objects. Available network adapters, corresponding to network adapter component objects, may also be installed.

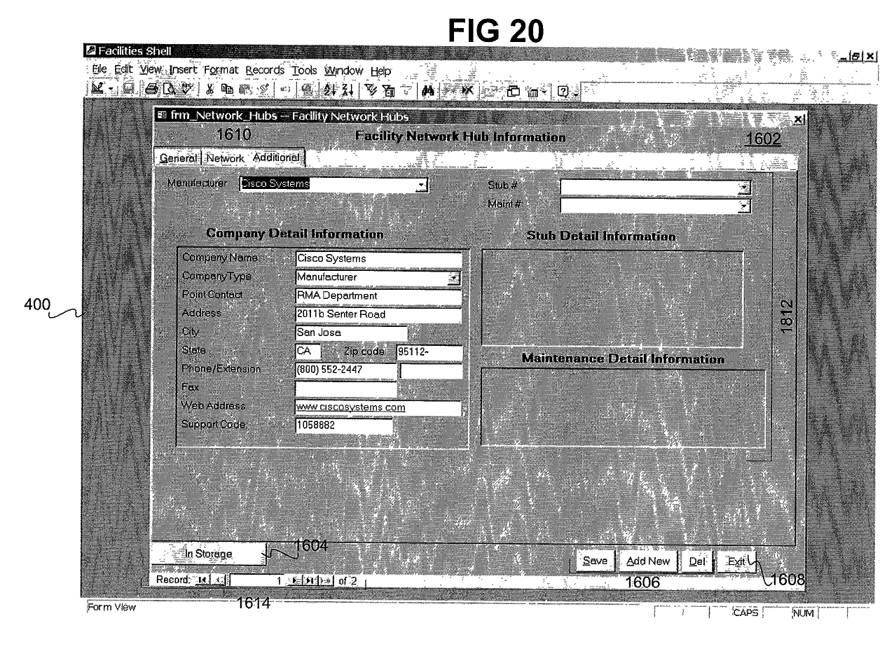

Clicking on the additional tab of the tabs 1610 causes the additional information area 1812 of FIG. 20 to be displayed within the window 1602. The additional information area 1812 includes additional information regarding the current network hub. This additional information can include manufacturer (company) information, stub information, and maintenance information.

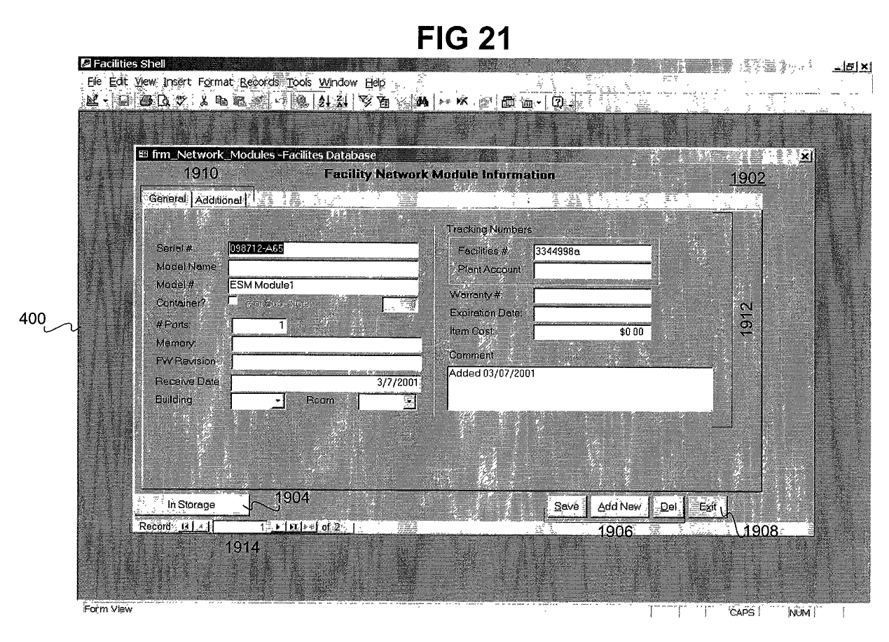

Referring back to FIG. 15, selecting the option for the network modules 1306 brings up the window 1902 of FIG. 21. The window 1902 includes a number of different parts. The main area 1912 shows general information regarding a current network module that can be installed on a system, where the network module is represented by a hardware component object within the database. As shown in FIG. 21, the general information can include serial number, model name, model number, number of ports, memory, firmware revision, receive date, building and room. This information can also include tracking numbers, warranty number, expiration date, item cost, and comments.

The button 1904 is used to indicate that the current network module is in storage. The buttons 1906 allow the user to save changes made within the window 1902, add a new network module component object, and delete the current network module component object. The exit button 1908 allows the user to close the window 1902 and go back to the window 1300 of FIG. 15. The window 1902 includes two tabs 1910, a general information tab corresponding to the general information area 1912, and an additional information tab. The records area 1914 allows the user to navigate among the different records, or network module component objects.

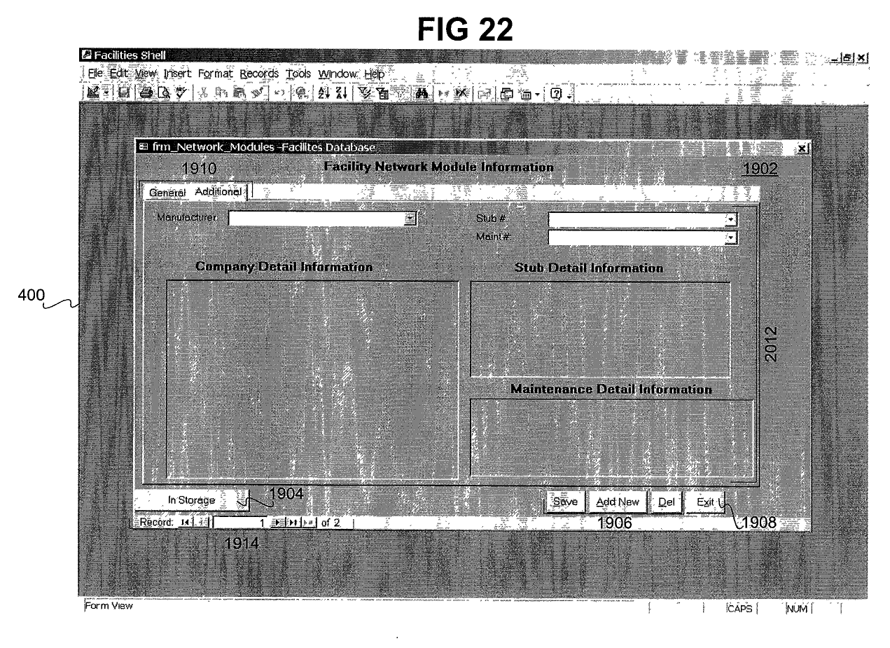

Clicking on the additional tab of the tabs 1910 causes the additional information area 2012 of FIG. 22 to be displayed within the window 1902. The additional information area 2012 includes additional information regarding the current network module. This information includes manufacturer (company) information, stub information, and maintenance information.

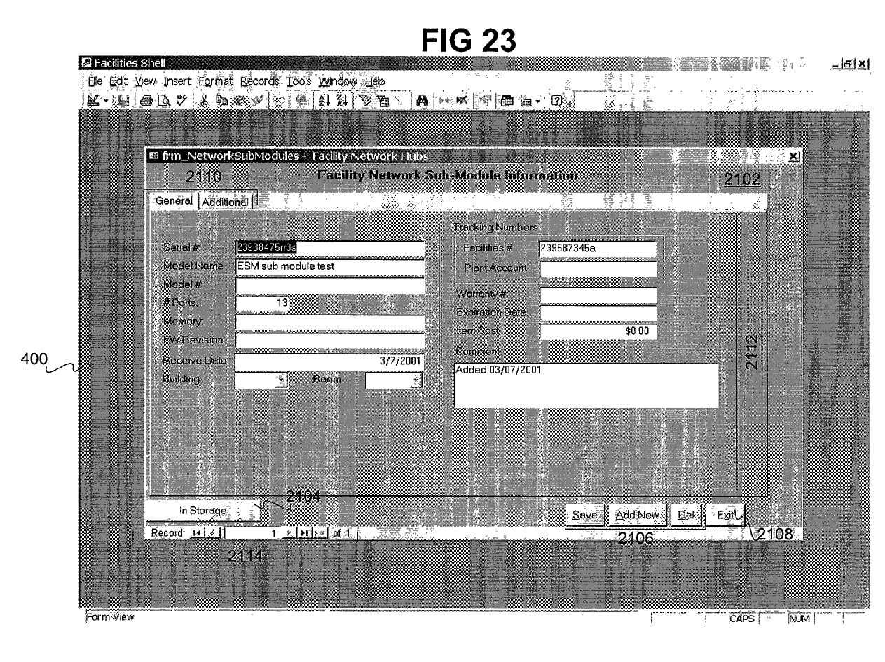

Referring back to FIG. 15, selecting the option for the network sub-modules 1308 brings up the window 2102 of FIG. 23. The window 2102 includes a number of different parts. The main area 2112 shows general information regarding a current network sub-module that can be installed on a system, where the network sub-module is represented by a hardware component object within the database. As shown in FIG. 23, the general information can include serial number, model name, model number, number of ports, memory, firmware revision, receive date, building and room. The information can also include tracking numbers, warranty number, expiration date, item cost, and comments.

The button 2104 is used to indicate that the current network sub-module is in storage. The buttons 2106 allow the user to save changes made within the window 2102, add a new network sub-module component object, and delete the current network sub-module component object. The exit button 2108 allows the user to close the window 2102 and go back to the window 1300 of FIG. 15. The window 2102 includes two tabs 2110, a general information tab corresponding to the general information area 2112, and an additional information tab. The records area 2114 allows the user to navigate among the different records, or network sub-module component objects.

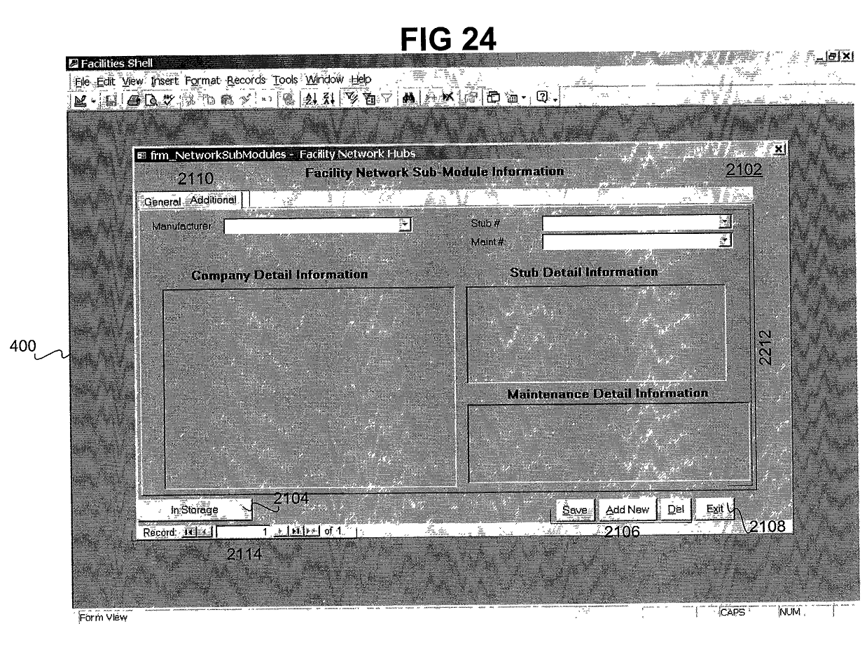

Clicking on the additional tab of the tabs 2110 causes the additional information area 2212 of FIG. 24 to be displayed within the window 2102. The additional information area 2212 includes additional information regarding the current network sub-module. This information includes manufacturer (company) information, stub information, and maintenance information.

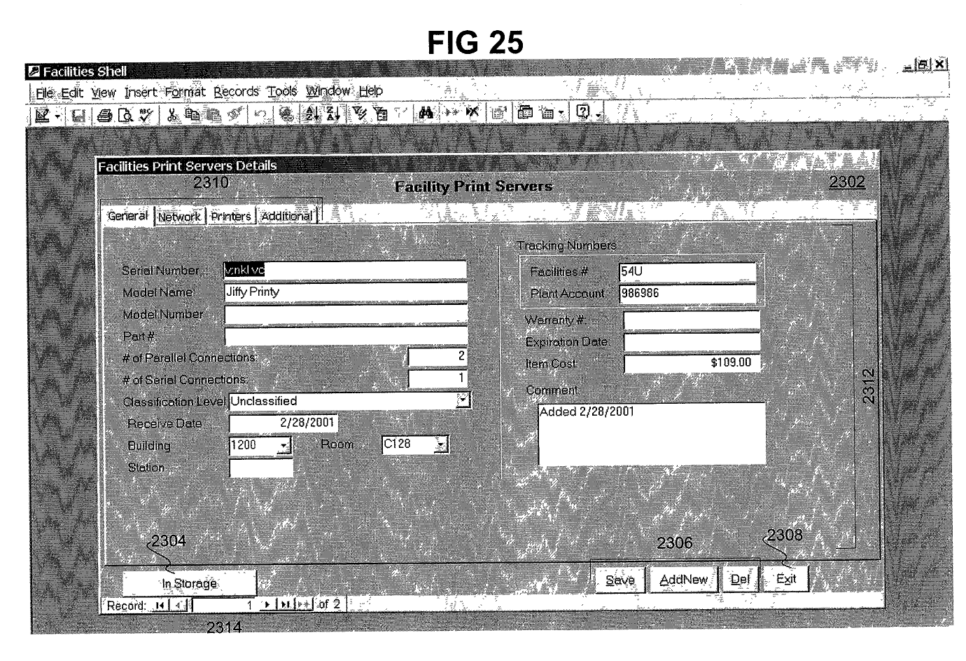

Referring back to FIG. 15, selecting the option for the network print servers 1310 brings up the window 2302 of FIG. 25. The window 2302 includes a number of different parts. The main area 2312 shows general information regarding a current print server, where the print server is represented by a print server container object. As shown in FIG. 25, the general information can include serial number, model name, model number, part number, number of parallel and serial connections, classification level, receive date, building, room, and station. The information can also include tracking numbers, warranty number, expiration date, item cost, and comments.

The button 2304 is used to indicate that the current printer server container object is in storage. The buttons 2306 allow the user to save changes made within the window 2302, add a new print server container object, and delete the current print server container object. The exit button 2308 allows the user to close the window 2302 and go back to the window 1300 of FIG. 15. The window 2302 includes four tabs 2310, a general information tab corresponding to the general information area 2312, a network information tab, a printers information tab, and an additional information tab. The records area 2314 allows the user to navigate among the different records, or print server container objects.

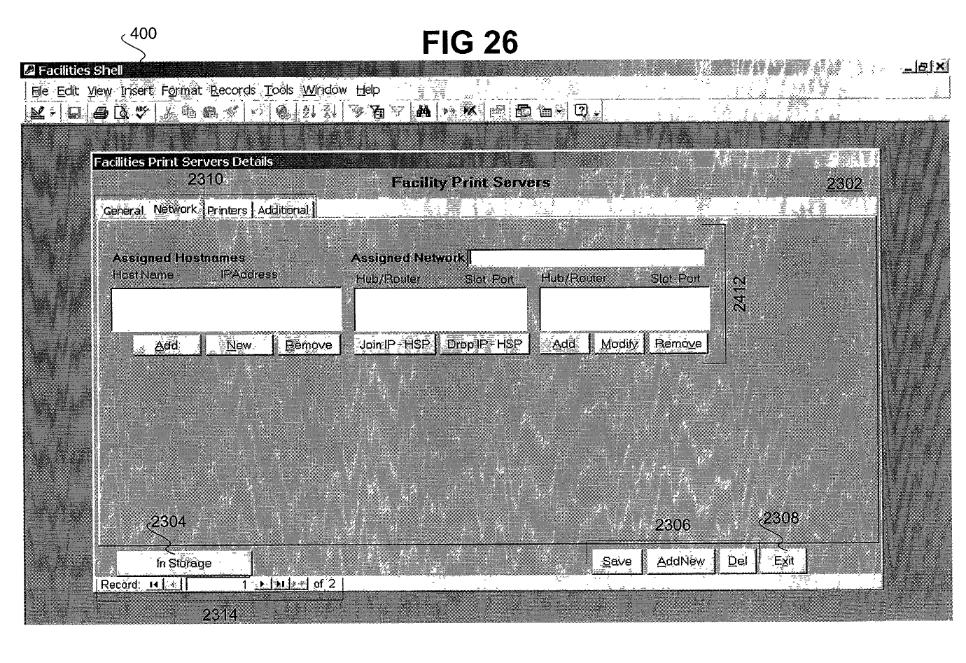

Clicking on the network tab of the tabs 2310 causes the network information area 2412 of FIG. 26 to be displayed within the window 2302. The network information area includes assigned hostnames and an assigned networks. Hub and router information is also included.

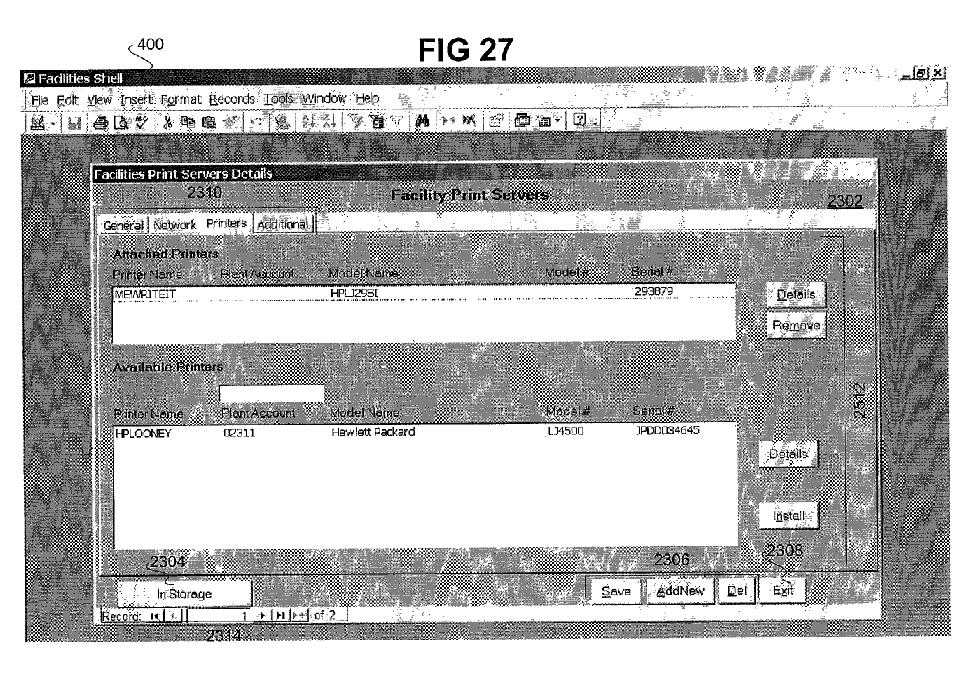

Clicking on the printers tab of the tabs 2310 causes the printer information area 2512 of FIG. 27 to be displayed within the window 2302. The printer information area includes printers attached to the current print server, that is, printer component objects assigned to the current print server container object. These installed printers can be removed. The printer information area also includes printers that are available for attachment or installation to the current print server. These available printers can then be installed.

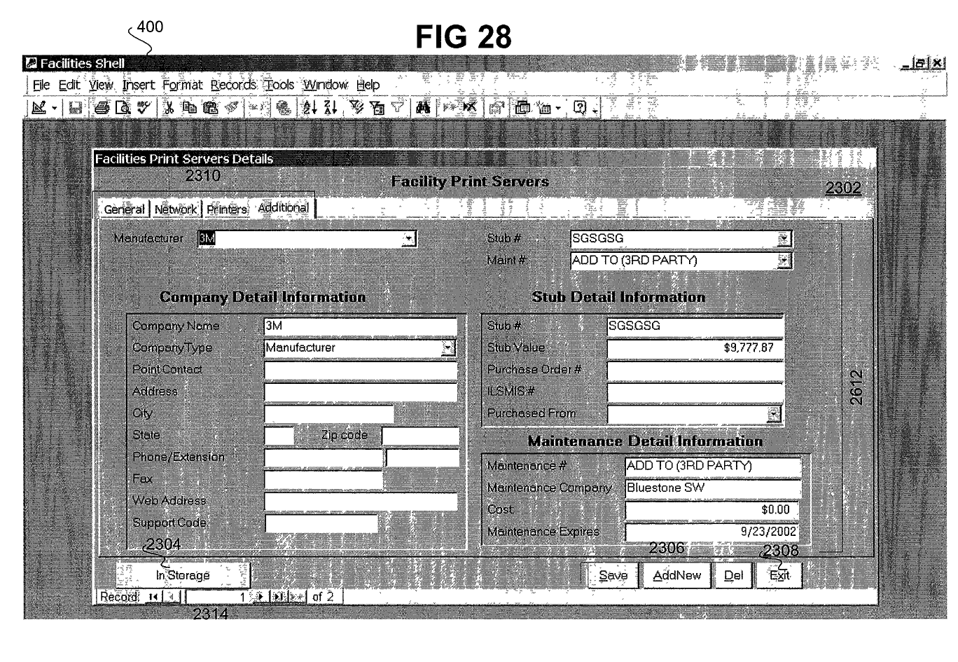

Clicking on the additional tab of the tabs 2310 causes the additional information area 2612 of FIG. 28 to be displayed within the window 2302. The additional information area 1612 includes additional information regarding the current print server. This information includes manufacturer (company) information, stub information, and maintenance information.

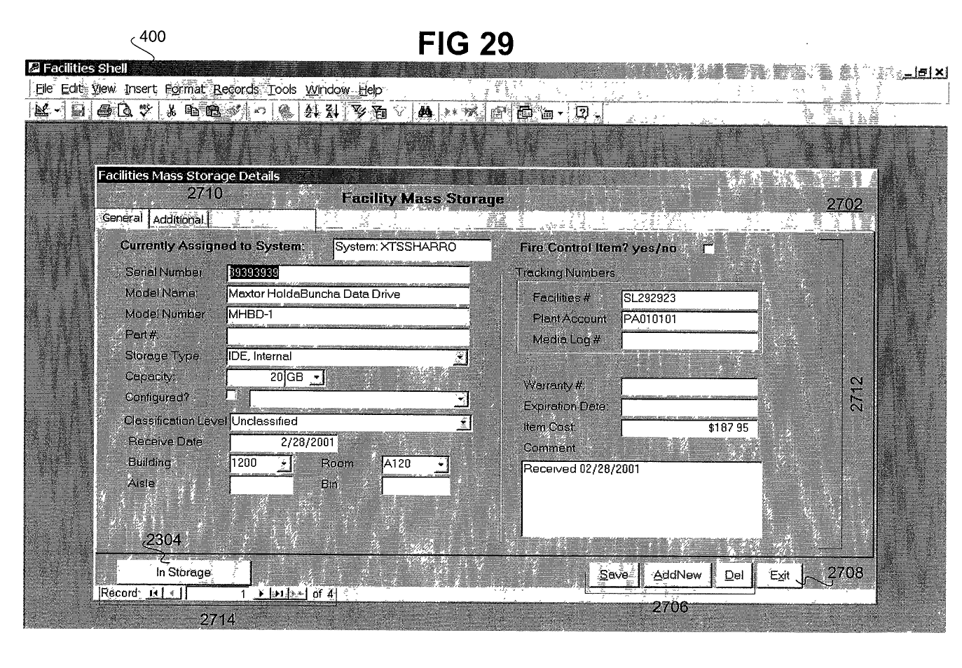

Referring back to FIG. 12, selecting the option for mass storage components 1256 brings up the window 2702 of FIG. 29. The window 2702 includes a number of different parts. The main area 2712 shows general information regarding a current mass storage device that can be or has been installed on a system, where the device is represented by a container object within the database. As shown in FIG. 29, the general information includes serial number, model number, model name, part number, storage type, capacity, classification level, receive data, building, room, aisle, and bin. The general information also includes tracking numbers, warranty number, expiration date, item cost, and comments.

The button 2704 is used to indicate that the current mass storage device is in storage. The buttons 2706 allow the user to save changes made within the window 2702, add a new mass storage device, and delete the current device. The exit button 2708 allows the user to close the window 2702 and go back to the window 1250 of FIG. 12. The window 2702 includes two tabs, a general information tab corresponding to the general information area 2712, and an additional information tab. The records area 2714 allows the user to navigate among the different records, or mass storage container objects.

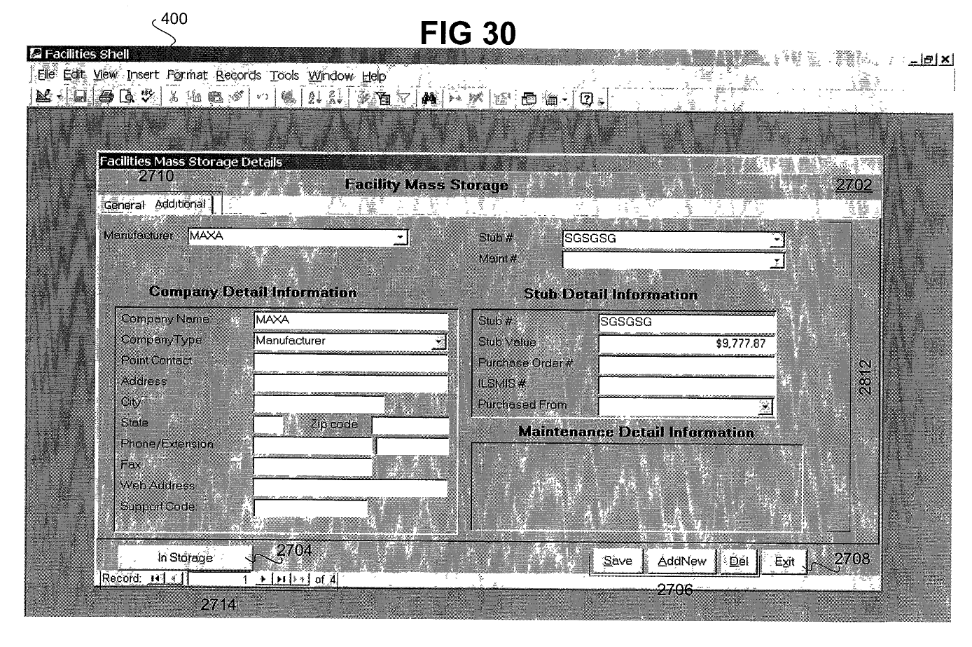

Clicking on the additional tab of the tabs 2710 causes the additional information area 2812 of FIG. 30 to be displayed within the window 2702. The additional information area 2812 includes additional information regarding the current mass storage device. This information includes manufacturer (company) information, stub information, and maintenance information.

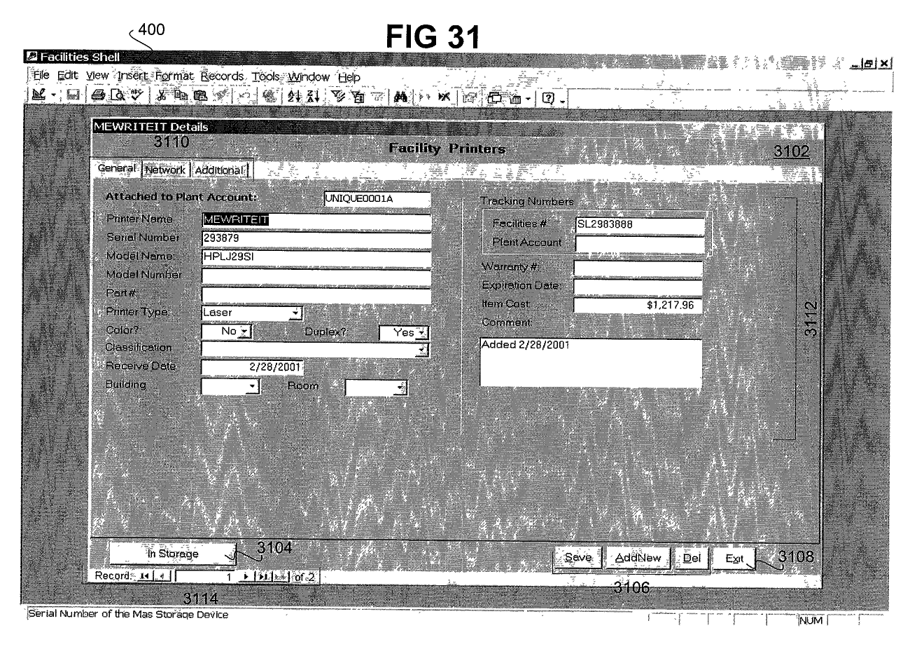

Referring back to FIG. 12, selecting the option for printer components 1258 brings up the window 3102 of FIG. 31. The window 3102 includes a number of different parts. The main area 3112 shows general information regarding a current printer component that can be or has been installed on a system, where the device is represented by a hardware component object within the database. As shown in FIG. 31, the information includes printer name, serial number, model name, model number, part number, printer type, whether the printer is color and/or duplex, classification, receive date, building, and room. The general information also can include tracking numbers, warranty number, expiration date, item cost, and comments.

The button 3104 is used to indicate that the current printer is in storage. The buttons 3106 allow the user to save changes made within the window 3102, add a new printer, and delete the current printer. The exit button 3108 allows the user to close the window 3102 and go back to the window 1250 of FIG. 12. The window 3102 includes three tabs, a general information tab, a network information tab, and an additional information tab. The records area 3114 allows the user to navigate among the different records, or printer component objects.

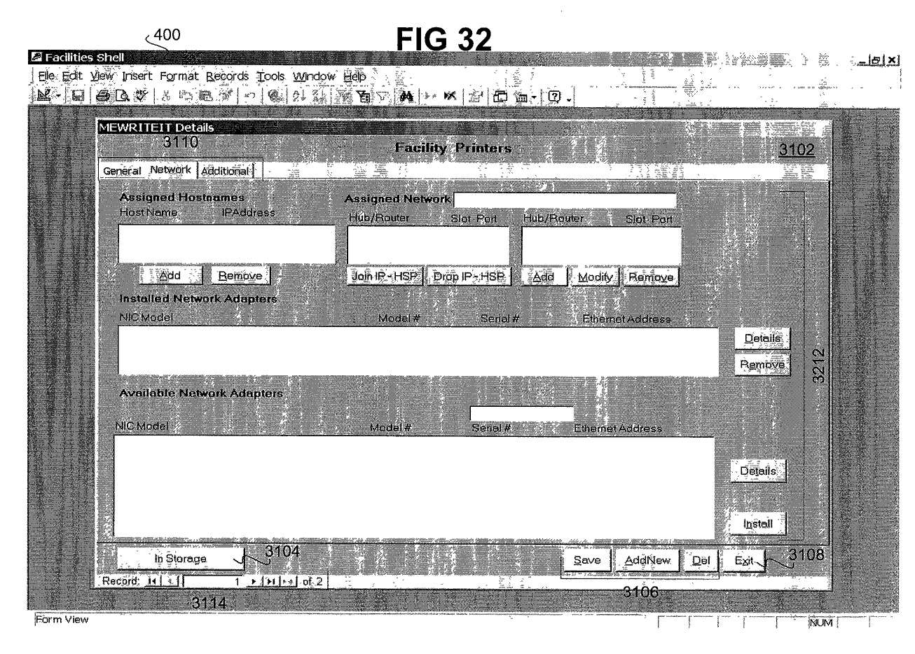

Clicking on the network tab of the tabs 3110 causes the network information area 3212 of FIG. 32 to be displayed within the window 3102. The network information area 3212 includes network connectivity information regarding the current printer. This information includes assigned hostnames, which can be added and removed, an assigned network, and hub and router information. The network information also includes installed network adapters on the printer, which can be removed. Finally, the network information includes available network adapters that may be installed on the printer. It is noted that where the printer is a network printer, such that it has network connectivity information, the printer is represented by a container object within the database, as opposed to a hardware component object. This is so that the network adapters, which themselves are represented by hardware component objects within the database, can be assigned to the container object representing the printer.

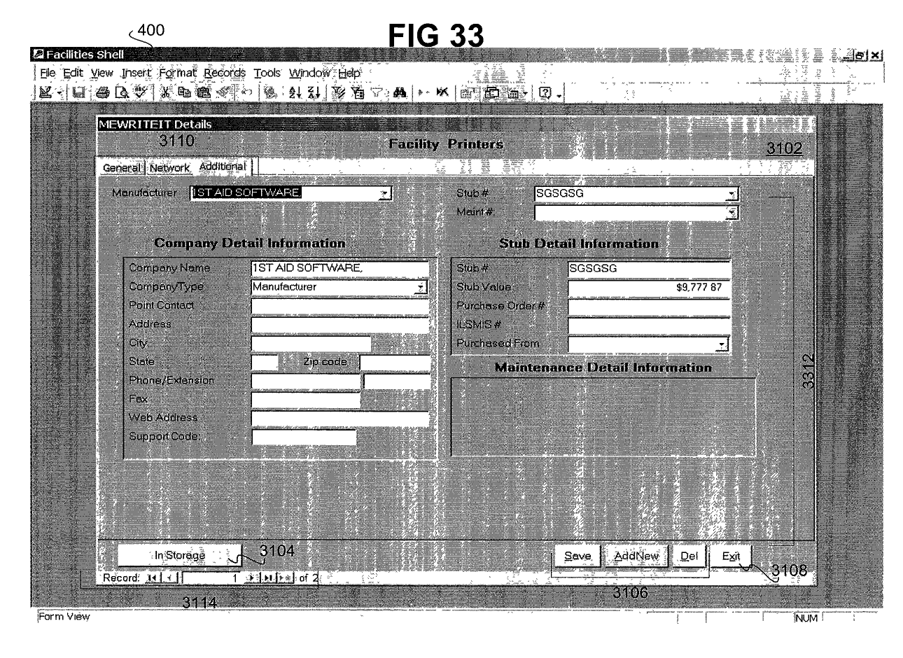

Clicking on the additional tab of the tabs 3110 causes the additional information area 3312 of FIG. 33 to be displayed within the window 3102. The additional information area 3312 includes additional information regarding the current printer. This information includes manufacturer (company) information, stub information, and maintenance information.

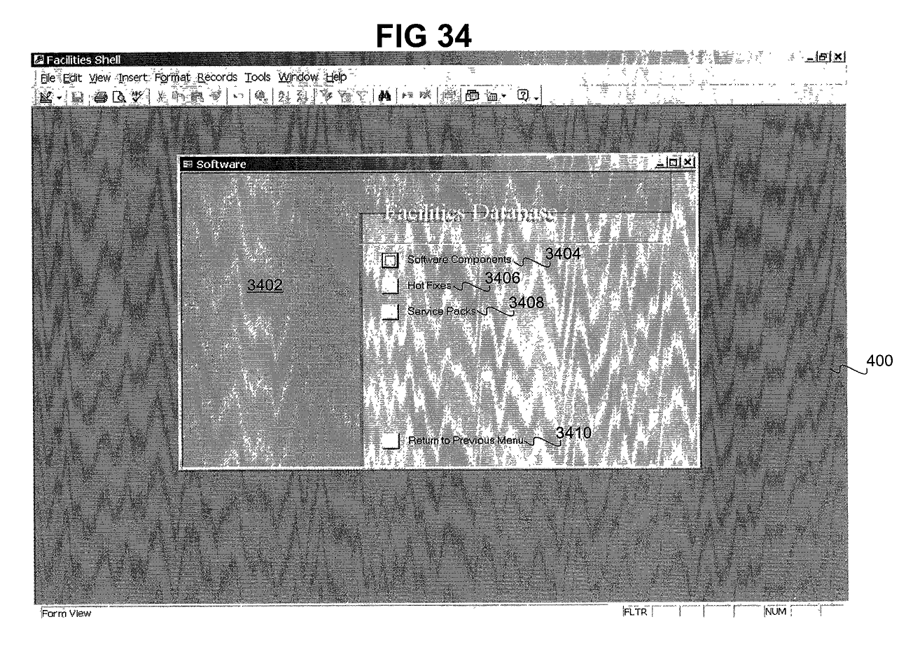

Referring back to FIG. 12, selecting the option for software components 1260 brings up the window 3402 of FIG. 34. Four different options are selectable in the window 3402. The user may specify software components 3404, hot fixes 3406, or service packs 3408. The user may also return to the window 1250 of FIG. 12 by selecting the return to previous menu option 3410.

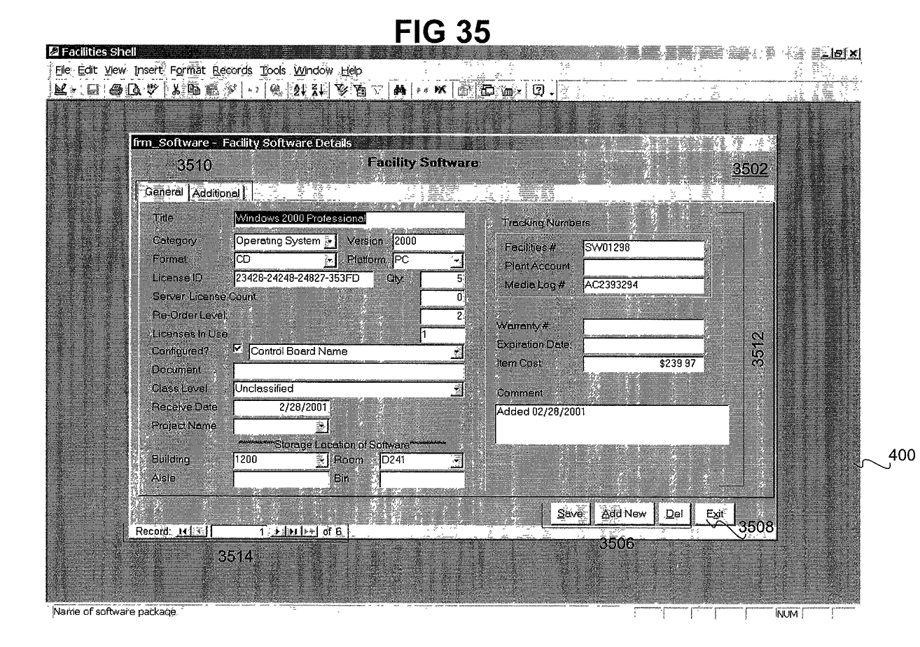

Selecting the option for the software components 3404 brings up the window 3502 of FIG. 35. The window 3502 includes a number of different parts. The main area 3512 shows general information regarding a current software component that can be installed on a system, where the software component is represented by a software component object within the database. As shown in FIG. 35, the general information can include the following: title, category, version, format, platform, license, quantity, server license count, re-order level, licenses in use, document, class level, receive date, project name, and storage location information. The general information can also include tracking numbers, warranty number, expiration date, item cost, and comments.

The buttons 3506 allow the user to save changes made within the window 3502, add a new software component object, and delete the current software component object. The exit button 3508 allows the user to close the window 3502 and go back to the window 3402 of FIG. 34. The window 3502 also includes two tabs 3510, such that the main area 3512 corresponds to the general information tab. There also is an additional information tab. The records area 3514 allows the user to navigate among the different records, or software component objects.

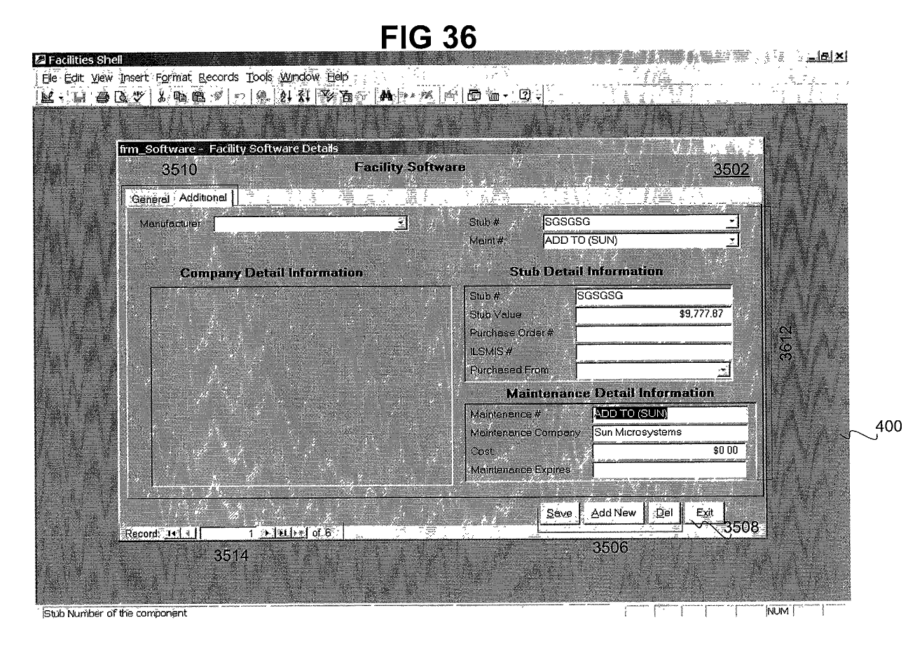

Clicking on the additional tab of the tabs 3510 causes the additional information area 3612 of FIG. 36 to be displayed within the window 3502. The additional information area 3612 includes additional information regarding the current software component. This information includes manufacturer (company) information, stub information, and maintenance information.

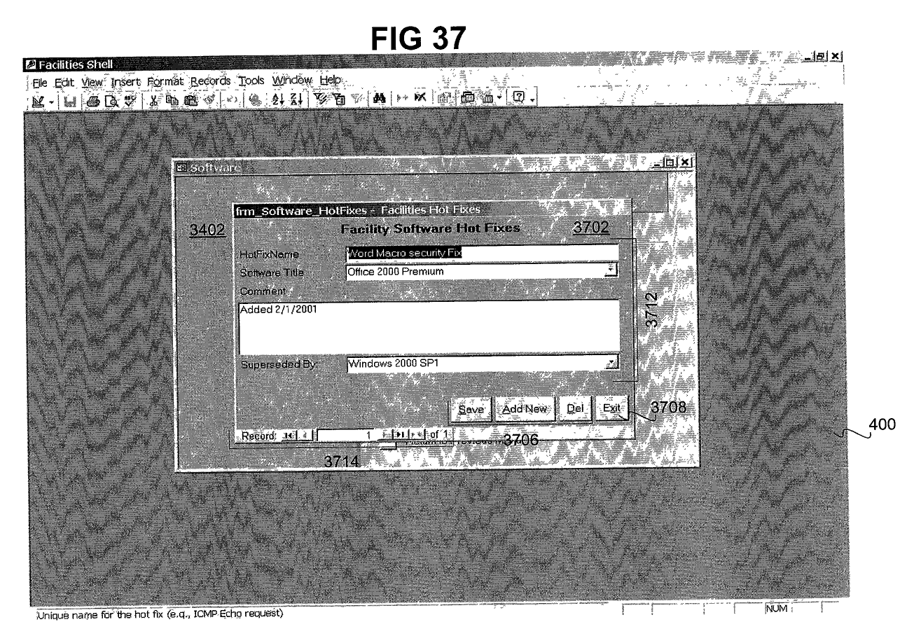

Referring back to FIG. 34, selecting the option for the hot fixes 3406 brings up the window 3702 of FIG. 37. The window 3702 includes a number of different parts. The main area 3712 shows information regarding a current software hot fix, which is represented by a software component object within the database. As shown in FIG. 37, the general information can include the following: name, software title, comments, and superseded by information.

The buttons 3706 allow the user to save changes made within the window 3702, add a new hot fix, and delete the current hot fix. The exit button 3708 allows the user to close the window 3702 and go back to the window 3402 of FIG. 34. The records area 3714 allows the user to navigate among the different records, or software hot fixes.

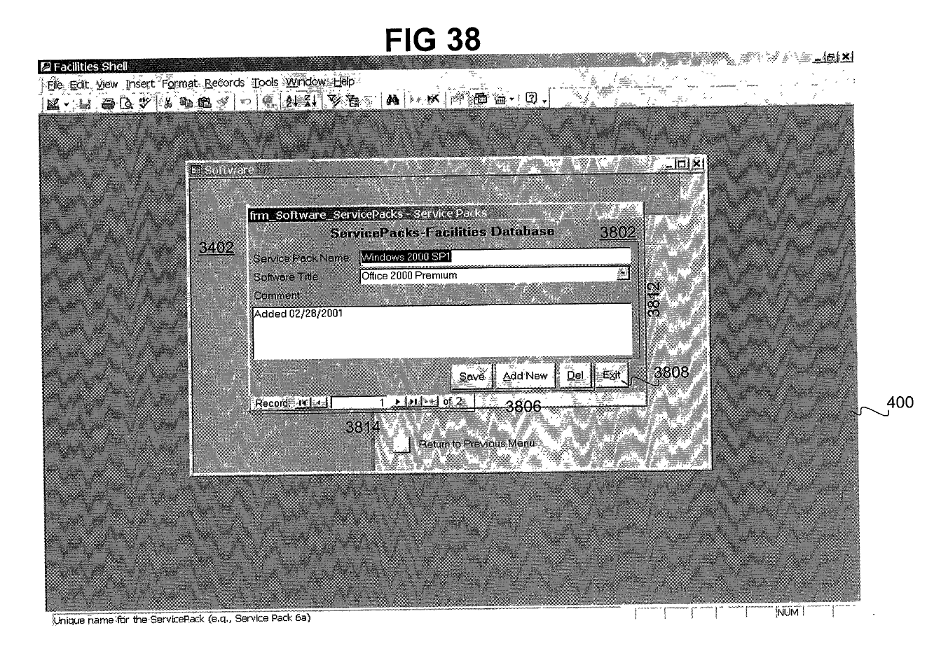

Referring back to FIG. 34, selecting the option for the service packs 3408 brings up the window 3802 of FIG. 38. The window 3802 includes a number of different parts. The main area 3812 shows information regarding a current software service pack, which is represented by a software component object within the database. As shown in FIG. 38, the general information can include the following: name, software title, and comments.

The buttons 3806 allow the user to save changes made within the window 3802, add a new service pack, and delete the current service pack. The exit button 3808 allows the user to close the window 3802 and go back to the window 3402 of FIG. 34. The records area 3814 allows the user to navigate among the different records, or software service packs.

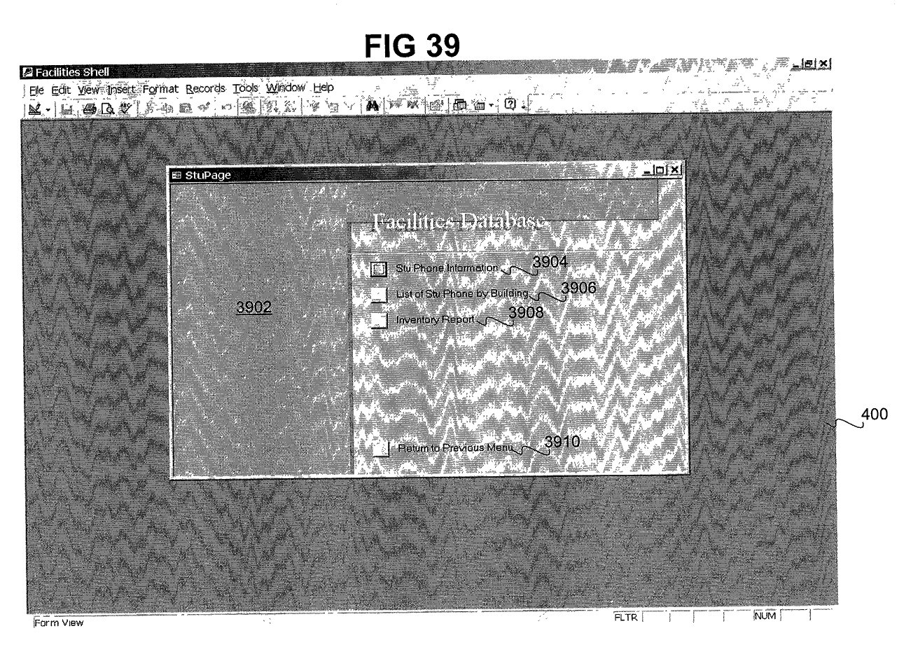

Referring back to FIG. 12, selecting the option for the STU phone components 1262 brings up the window 3902 of FIG. 39. Four different options are selectable in the window 3902. The user may specify STU phone information 3904, a list of STU phones by building 3906, or an inventory report 3908. The list 3906 and report 3908 options are common options in database programs, and are not described in detail herein. The user may also return to the window 1250 of FIG. 12 by selecting the return to previous menu option 3910.

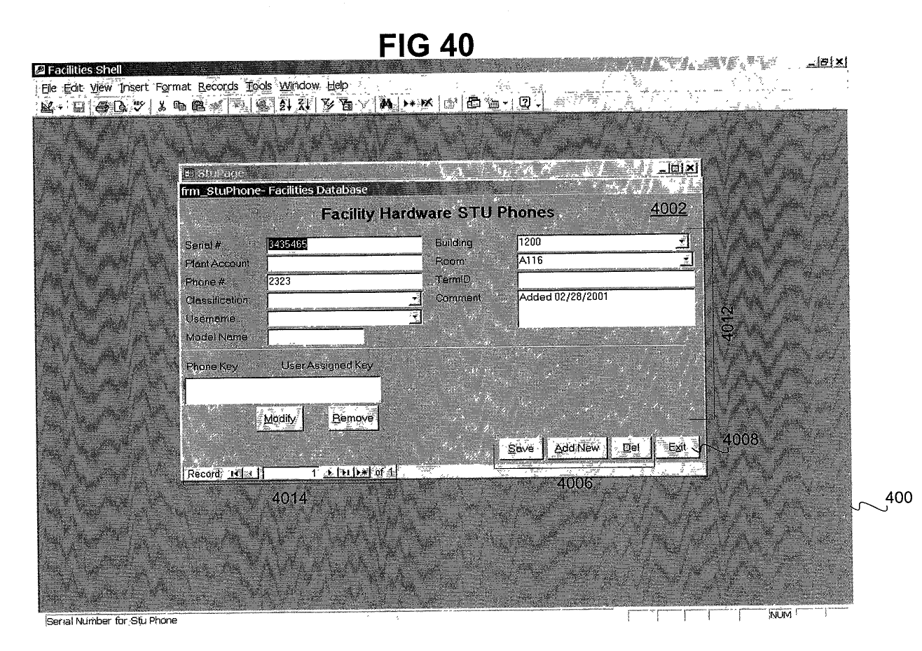

Selecting the option for the STU phone information 3904 brings up the window 4002 of FIG. 40. The window 4002 includes a number of different parts. The main area 4012 shows general information regarding a current STU phone that can be installed on a system, where the phone is represented by a hardware component object within the database. As shown in FIG. 40, this information can include the following: serial number, plant account, phone number, classification, user name, model name, building, room, and comments. The information can also include phone keys and user assigned keys, which can be modified and removed.

The buttons 4006 allow the user to save changes made within the window 4002, add a new phone, and delete the current phone. The exit button 4008 allows the user to close the window 4002 and go back to the window 3902 of FIG. 39. The records area 4014 allows the user to navigate among the different records, or phones.

A commercial embodiment of the invention can be implemented as described in the source code listed in the Appendix. The source code is in the Visual Basic for Applications (VBA) programming language. The source code is preferably implemented in conjunction with a Microsoft Access database.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

What is claimed is:

1. A database for managing equipment comprising:
one or more container objects, each container object corresponding to an equipment on which other equipment can be installed;
one or more hardware component objects, each hardware component object corresponding to a hardware component that is installable on the equipment corresponding to a container object such that the hardware component object is assignable to the container object.

2. The database of claim 1, further comprising one or more software component objects, each software component object corresponding to a software component that is installable on the equipment corresponding to a container object such that the software component object is assignable to the container object.

3. The database of claim 2, wherein each software component object is assigned to a container object when the software component to which the software component object corresponds is installed on the equipment to which the container object corresponds.

4. The database of claim 2, wherein the software component to which each software component object corresponds is selected from the group of software components essentially consisting of software programs, hot fix update programs, and service pack update programs.

5. The database of claim 1, wherein the equipment to which each container object corresponds is selected from the group of equipment essentially consisting of a system, a mass storage device, a printer, and a print server.

6. The database of claim 1, wherein each hardware component object is assigned to a container object when the hardware component to which the hardware component object corresponds is installed on the equipment to which the container object corresponds.

7. The database of claim 1, wherein the hardware component to which each hardware component object corresponds is selected from the group of hardware components essentially consisting of displays, docking stations, general office equipment, imaging equipment, input devices, interface drives, logic analyzers, memory, modems, network devices, removable hard drive cases, scanners, storage devices, terminals, test tools, uninterruptible power supplies, workstations, and zip drives.

8. The database of claim 1, wherein the hardware component to which each hardware component object corresponds is selected from the group of hardware components essentially consisting of network cards, network hubs, network modules, network sub-modules, and network print servers.

9. The database of claim 1, wherein the hardware component to which each hardware component object corresponds is selected from the group of hardware components essentially consisting of mass storage devices, phones, printers, and print servers.

10. The database of claim 1, farther comprising one or more hybrid objects, each hybrid object corresponding to equipment that is both installable on other equipment and on which other equipment can be installed.

11. The database of claim 1, wherein the database is relational.

12. A method for managing equipment comprising:
instantiating one or more container objects from one or more different container object types, each container object corresponding to an equipment on which other equipment can be installed; and,
instantiating one or more hardware component objects from one or more different hardware component object types, each hardware component object corresponding to a hardware component that is installable on the equipment corresponding to a container object such that the hardware component object is assignable to the container object.

13. The method of claim 12, further comprising instantiating one or more software component objects from one or more different software component object types, each software component object corresponding to a software component that is installable on the equipment corresponding to a container object such that the software component object is assignable to the container object.

14. The method of claim 13, further comprising creating, modifying, and deleting the one or more different software component object types.

15. The method of claim 13, further comprising assigning each software component to a container object when the software component to which the software component object corresponds is installed on the equipment to which the container object corresponds.

16. The method of claim 12, further comprising creating, modifying, and deleting the one or more different container object types.

17. The method of claim 12, further comprising creating, modifying, and deleting the one or more different hardware component object types.

18. The method of claim 12, further comprising assigning each hardware component object to a container object when the hardware component to which the hardware component object corresponds is installed on the equipment to which the container object corresponds.

19. A computer-readable medium having instructions stored thereon for execution by a processor to perform the method of claim 12.

20. A database for managing equipment comprising:
container object means for corresponding to an equipment on which other equipment can be installed;
hardware component object means for corresponding to a hardware component that is installable on the equipment corresponding to the container object means such that the hardware component object means is assignable to the container object means; and,
software component object means for corresponding to a software component that is installable on the equipment corresponding to the container object such that the software component object means is assignable to the container object means.
